(19) United States
(12) Patent Application Publication
(10) Pub. No.: US 2015/0304997 A1
(43) Pub. Date: Oct. 22, 2015

(54) METHOD FOR TRANSMITTING AND RECEIVING SIGNAL IN MULTIPLE CELL-BASED WIRELESS COMMUNICATION SYSTEM, AND APPARATUS FOR SAME

(71) Applicant: LG ELECTRONICS INC., Yeongdeungpo-gu Seoul (KR)

(72) Inventors: Jonghyun Park, Seoul (KR); Kijun Kim, Seoul (KR); Suckchel Yang, Seoul (KR)

(73) Assignee: LG ELECTRONICS INC., Seoul (KR)

(21) Appl. No.: 14/442,065

(22) PCT Filed: Mar. 26, 2014
(86) PCT No.: PCT/KR2014/002550

§ 371 Date: May 11, 2015

Related U.S. Application Data
(60) Provisional application No. 61/805,503, filed on Mar. 26, 2013.

(51) Int. Cl. H04W 72/04; H04B 7/06; H04L 5/00; H04B 7/02

(52) U.S. Cl. CPC H04W 72/042; H04B 7/024; H04B 7/0639; H04L 5/0023; H04L 5/0035

(57) ABSTRACT

The present application discloses a method for receiving a signal by a user equipment in a multiple cell-based wireless communication system. Specifically, the method comprises the steps of: configuring a plurality of parameter sets for receiving a downlink data channel through an upper layer; receiving control information for receiving a downlink data channel from a serving cell; and receiving a downlink data channel including a plurality of code words from at least one of the serving cell and an adjacent cell through a plurality of layer groups, based on the control information, wherein one layer group corresponds to one code word, the control information includes layer group information for each of the plurality of layer groups, and the layer group information includes information indicating one of the plurality of parameter sets.

### TECHNICAL FIELD

The present invention relates to a wireless communication system and, more particularly, to a method for transmitting and receiving a signal in a multi-cell based wireless communication system and an apparatus therefor.

### BACKGROUND ART

3GPP LTE (3rd generation partnership project long term evolution hereinafter abbreviated LTE) communication system is schematically explained as an example of a wireless communication system to which the present invention is applicable.

FIG. 1 is a schematic diagram of E-UMTS network structure as one example of a wireless communication system. E-UMTS (evolved universal mobile telecommunications system) is a system evolved from a conventional UMTS (universal mobile telecommunications system). Currently, basic standardization works for the E-UMTS are in progress by 3GPP. E-UMTS is called LTE system in general. Detailed contents for the technical specifications of UMTS and E-UMTS refers to release 7 and release 8 of “3rd generation partnership project; technical specification group radio access network”, respectively.

Referring to FIG. 1, E-UMTS includes a user equipment (UE), an eNode B (eNB), and an access gateway (hereinafter abbreviated AG) connected to an external network in a manner of being situated at the end of a network (E-UTRAN). The eNode B may be able to simultaneously transmit multi data streams for a broadcast service, a multicast service and/or a unicast service.

One eNode B contains at least one cell. The cell provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells can be configured to provide corresponding bandwidths, respectively. An eNode B controls data transmissions/receptions to/from a plurality of the user equipments. For a downlink (hereinafter abbreviated DL) data, the eNode B informs a corresponding user equipment of time/frequency region on which data is transmitted, coding, data size, HARQ (hybrid automatic repeat and request) related information and the like by transmitting DL scheduling information. And, for an uplink (hereinafter abbreviated UL) data, the eNode B informs a corresponding user equipment of time/frequency region usable by the corresponding user equipment, coding, data size, HARQ-related information and the like by transmitting UL scheduling information to the corresponding user equipment. Interfaces for user-traffic transmission or control traffic transmission may be used between eNode Bs. A core network (CN) consists of an AG (access gateway) and a network node for user registration of a user equipment and the like. The AG manages a mobility of the user equipment by a unit of TA (tracking area) consisting of a plurality of cells.

Wireless communication technologies have been developed up to LTE based on WCDMA. Yet, the ongoing demands and expectations of users and service providers are consistently increasing. Moreover, since different kinds of radio access technologies are continuously developed, a new technological evolution is required to have a future competitiveness. Cost reduction per bit, service availability increase, flexible frequency band use, simple structure/open interface and reasonable power.

### DISCLOSURE

### Technical Problem

The present invention has been made in view of the above problems, and it is an object of the present invention to provide a method for transmitting and receiving a signal in a multi-cell based wireless communication system and an apparatus therefor.

### Technical Solution

The object of the present invention can be achieved by providing a method for receiving a signal by a user equipment in a multi-cell based wireless communication system, including configuring a plurality of parameter sets for receiving a downlink data channel through a higher layer; receiving control information for receiving the downlink data channel from a serving cell; and receiving the downlink data channel including a plurality of codewords through a plurality of layer groups from at least one of the serving cell and a neighboring cell based on the control information, wherein one layer group corresponds to one codeword, the control information includes layer group information for each of the layer groups, and the layer group information includes information indicating one of the parameter sets.

In another aspect of the present invention, provided herein is a user equipment in a multi-cell based wireless communication system, including a wireless communication module for transmitting and receiving a signal to and from a base station; and a processor for processing the signal, wherein the processor configures a plurality of parameter sets for receiving a downlink data channel through a higher layer and controls the wireless communication module to receive control information for receiving the downlink data channel from a serving cell and receive the downlink data channel including a plurality of codewords through a plurality of layer groups from at least one of the serving cell and a neighboring cell based on the control information, and wherein one layer group corresponds to one codeword, the control information includes layer group information for each of the layer groups, and the layer group information includes information indicating one of the parameter sets.

In the above embodiments, each of the layer groups may include one or more layers, and the layer group information may include information for mapping the one codeword to one or more layers. First reference signals for the downlink data channel may be defined as different antenna ports, the first reference signals mapped to different layer groups may be mapped to the one or more layers through frequency division multiplexing, and the first reference signals mapped to the same layer group may be mapped to the one or more layers through code division multiplexing.

The parameter sets may include information about a second reference signal assumed to have the same large-scale properties as a first reference signal for the downlink data channel. The large-scale properties may include at least one of Doppler spread, Doppler shift, average delay, and delay spread.

The information about the second reference signal included in each of the layer group information may be different. First reference signals for the downlink data channel may be generated based on different cell identifiers for the respective layer groups.

### Advantageous Effects

According to embodiments of the present invention, a user equipment can efficiently transmit and receive a signal in a multi-cell based wireless communication system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a schematic diagram of E-UMTS network structure as one example of a wireless communication system.

FIG. 2 is a diagram for structures of control and user planes of radio interface protocol between a 3GPP radio access network standard-based user equipment and E-UTRAN.

FIG. 3 is a diagram for explaining physical channels used for 3GPP system and a general signal transmission method using the physical channels.

FIG. 4 is a diagram for a structure of a radio frame in LTE system.

FIG. 5 is a diagram for a structure of a downlink radio frame in LTE system.

FIG. 6 is a diagram for a structure of an uplink radio frame in LTE system.

FIG. 7 is a diagram for a configuration of a multiple antenna communication system.

FIG. 8 and FIG. 9 are diagrams of a structure of a reference signal in LTE system supportive of downlink transmission using 4 antennas.

FIG. 10 is a diagram for an example of assigning a downlink DM-RS defined by a current 3GPP standard document.

FIG. 11 is a diagram for an example of a CSI-RS configuration #0 in case of a normal CP among downlink CSI-RS configurations defined by a current 3GPP standard document.

FIG. 12 illustrates an example of signal transmission using a JT scheme through cooperation between three transmission points.

FIG. 13 illustrates an example of signal transmission using an ILJT scheme through cooperation between three transmission points.

FIG. 14 illustrates an example of a structure of a PDCCH in an LTE system.

FIG. 15 illustrates another example of a structure of a PDCCH in an LTE system.

FIG. 16 illustrates an example of the contents of DCI classified according to DLG according to an embodiment of the present invention.

FIG. 17 illustrates another example of the contents of DCI classified according to DLG according to an embodiment of the present invention.

FIG. 18 is a block diagram for an example of a communication device according to one embodiment of the present invention.

### BEST MODE

In the following description, compositions of the present invention, effects and other characteristics of the present invention can be easily understood by the embodiments of the present invention explained with reference to the accompanying drawings. Embodiments explained in the following description are examples of the technological features of the present invention applied to 3GPP system.

In this specification, the embodiments of the present invention are explained using an LTE system and an LTE-A system, which is exemplary only. The embodiments of the present invention are applicable to various communication systems corresponding to the above mentioned definition. In particular, although the embodiments of the present invention are described in the present specification on the basis of FDD, this is exemplary only. The embodiments of the present invention may be easily modified and applied to H-FDD or TDD.

And, in the present specification, a base station can be named by such a comprehensive terminology as an RRH (remote radio head), an eNB, a TP (transmission point), an RP (reception point), a relay and the like.

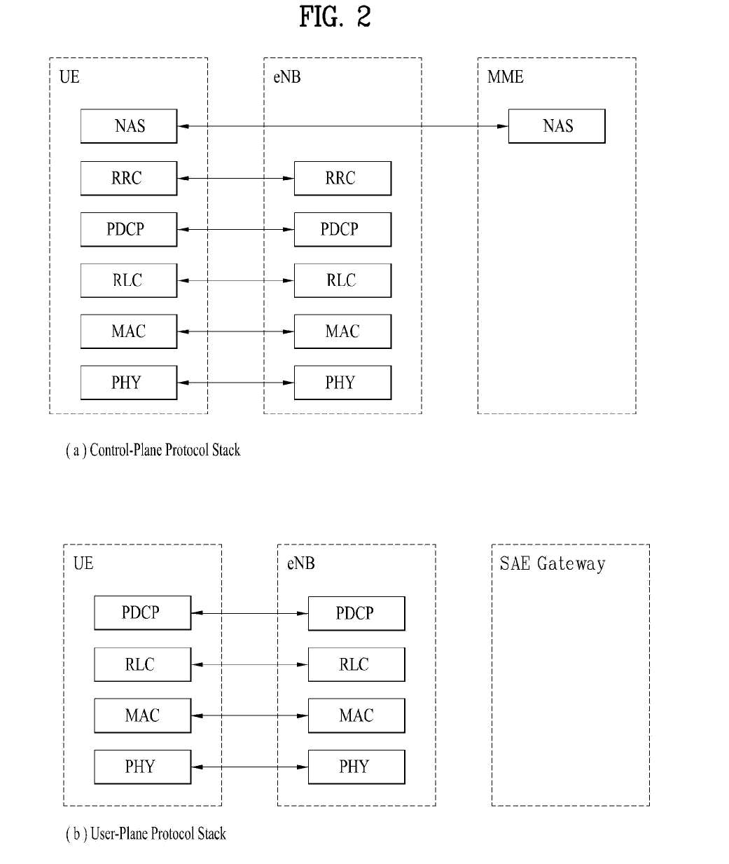

FIG. 2 is a diagram for structures of control and user planes of radio interface protocol between a 3GPP radio access network standard-based user equipment and E-UTRAN. The control plane means a path on which control messages used by a user equipment (UE) and a network to manage a call are transmitted. The user plane means a path on which such a data generated in an application layer as audio data, internet packet data, and the like are transmitted.

A physical layer, which is a 1st layer, provides higher layers with an information transfer service using a physical channel. The physical layer is connected to a medium access control layer situated above via a transport channel. Data moves between the medium access control layer and the physical layer on the transport channel. Data moves between a physical layer of a transmitting side and a physical layer of a receiving side on the physical channel. The physical channel utilizes time and frequency as radio resources. Specifically, the physical layer is modulated by OFDMA (orthogonal frequency division multiple access) scheme in DL and the physical layer is modulated by SC-FDMA (single carrier frequency division multiple access) scheme in UL.

Medium access control (hereinafter abbreviated MAC) layer of a 2nd layer provides a service to a radio link control (hereinafter abbreviated RLC) layer, which is a higher layer, on a logical channel. The RLC layer of the 2nd layer supports a reliable data transmission. The function of the RLC layer may be implemented by a function block within the MAC. PDCP (packet data convergence protocol) layer of the 2nd layer performs a header compression function to reduce unnecessary control information, thereby efficiently transmitting such IP packets as IPv4 packets and IPv6 packets in a narrow band of a radio interface.

Radio resource control (hereinafter abbreviated RRC) layer situated in the lowest location of a 3rd layer is defined on a control plane only. The RRC layer is responsible for control of logical channels, transport channels and physical channels in association with a configuration, a re-configuration and a release of radio bearers (hereinafter abbreviated RBs). The RB indicates a service provided by the 2nd layer for a data delivery between the user equipment and the network. To this end, the RRC layer of the user equipment and the RRC layer of the network exchange a RRC message with each other. In case that there is an RRC connection (RRC connected) between the user equipment and the RRC layer of the network, the user equipment lies in the state of RRC connected (connected mode). Otherwise, the user equipment lies in the state of RRC idle (idle mode). A non-access stratum (NAS) layer situated at the top of the RRC layer performs such a function as a session management, a mobility management and the like.

A single cell consisting of an eNode B (eNB) is set to one of 1.25 MHz, 2.5 MHz, 5 MHz, 10 MHz, 15 MHz, and 20 MHz of bandwidths and then provides a downlink or uplink transmission service to a plurality of user equipments. Different cells can be configured to provide corresponding bandwidths, respectively.

DL transport channels for transmitting data from a network to a user equipment include a BCH (broadcast channel) for transmitting a system information, a PCH (paging channel) for transmitting a paging message, a downlink SCH (shared channel) for transmitting a user traffic or a control message and the like. DL multicast/broadcast service traffic or a control message may be transmitted on the DL SCH or a separate DL MCH (multicast channel). Meanwhile, UL transport channels for transmitting data from a user equipment to a network include a RACH (random access channel) for transmitting an initial control message, an uplink SCH (shared channel) for transmitting a user traffic or a control message. A logical channel, which is situated above a transport channel and mapped to the transport channel, includes a BCCH (broadcast channel), a PCCH (paging control channel), a CCCH (common control channel), a MCCH (multicast control channel), a MTCH (multicast traffic channel) and the like.

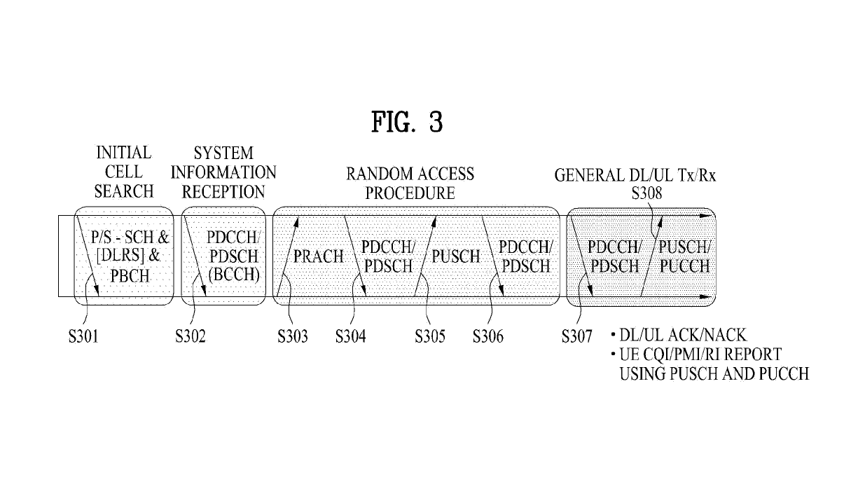

FIG. 3 is a diagram for explaining physical channels used for 3GPP system and a general signal transmission method using the physical channels.

If a power of a user equipment is turned on or the user equipment enters a new cell, the user equipment may perform an initial cell search job for matching synchronization with an eNode B and the like [S301]. To this end, the user equipment may receive a primary synchronization channel (P-SCH) and a secondary synchronization channel (S-SCH) from the eNode B, may be synchronized with the eNode B and may then obtain information such as a cell ID and the like. Subsequently, the user equipment may receive a physical broadcast channel from the eNode B and may be then able to obtain intra-cell broadcast information. Meanwhile, the user equipment may receive a downlink reference signal (DL RS) in the initial cell search step and may be then able to check a DL channel state.

Having completed the initial cell search, the user equipment may receive a physical downlink shared control channel (PDSCH) according to a physical downlink control channel (PDCCH) and an information carried on the physical downlink control channel (PDCCH). The user equipment may be then able to obtain a detailed system information [S302].

Meanwhile, if a user equipment initially accesses an eNode B or does not have a radio resource for transmitting a signal, the user equipment may be able to perform a random access procedure to complete the access to the eNode B [S303 to S306]. To this end, the user equipment may transmit a specific sequence as a preamble on a physical random access channel (PRACH) [S303/S305] and may be then able to receive a response message on PDCCH and the corresponding PDSCH in response to the preamble [S304/S306]. In case of a contention based random access procedure (RACH), it may be able to additionally perform a contention resolution procedure.

Having performed the above mentioned procedures, the user equipment may be able to perform a PDCCH/PDSCH reception [S307] and a PUSCH/PUCCH (physical uplink shared channel/physical uplink control channel) transmission [S308] as a general uplink/downlink signal transmission procedure. In particular, the user equipment receives a DCI (downlink control information) on the PDCCH. In this case, the DCI contains such a control information as an information on resource allocation to the user equipment. The format of the DCI varies in accordance with its purpose.

Meanwhile, control information transmitted to an eNode B from a user equipment via UL or the control information received by the user equipment from the eNode B includes downlink/uplink ACK/NACK signals, CQI (Channel Quality Indicator), PMI (Precoding Matrix Index), RI (Rank Indicator) and the like. In case of 3GPP LTE system, the user equipment may be able to transmit the aforementioned control information such as CQI/PMI/RI and the like on PUSCH and/or PUCCH.

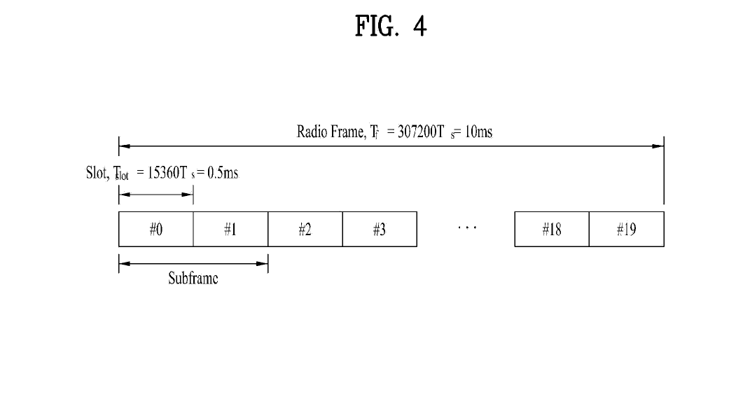

FIG. 4 is a diagram for a structure of a radio frame in LTE system.

Referring to FIG. 4, one radio frame has a length of 10 ms (327,200×T_{S}) and is constructed with 10 subframes in equal size. Each of the subframes has a length of 1 ms and is constructed with two slots. Each of the slots has a length of 0.5 ms (15,360×T_{S}). In this case, Tₛ indicates a sampling time and is represented as Tₛ=1/(15 kHz×2048)=3.2552×10⁻⁸ (i.e., about 33 ns). The slot includes a plurality of OFDM symbols in a time domain and also includes a plurality of resource blocks (RBs) in a frequency domain. In the LTE system, one resource block includes ‘12 subcarriers×7 or 6 OFDM symbols’. A transmission time interval (TTI), which is a unit time for transmitting data, can be determined by at least one subframe unit. The aforementioned structure of a radio frame is just exemplary. And, the number of subframes included in a radio frame, the number of slots included in a subframe and the number of OFDM symbols included in a slot may be modified in various ways.

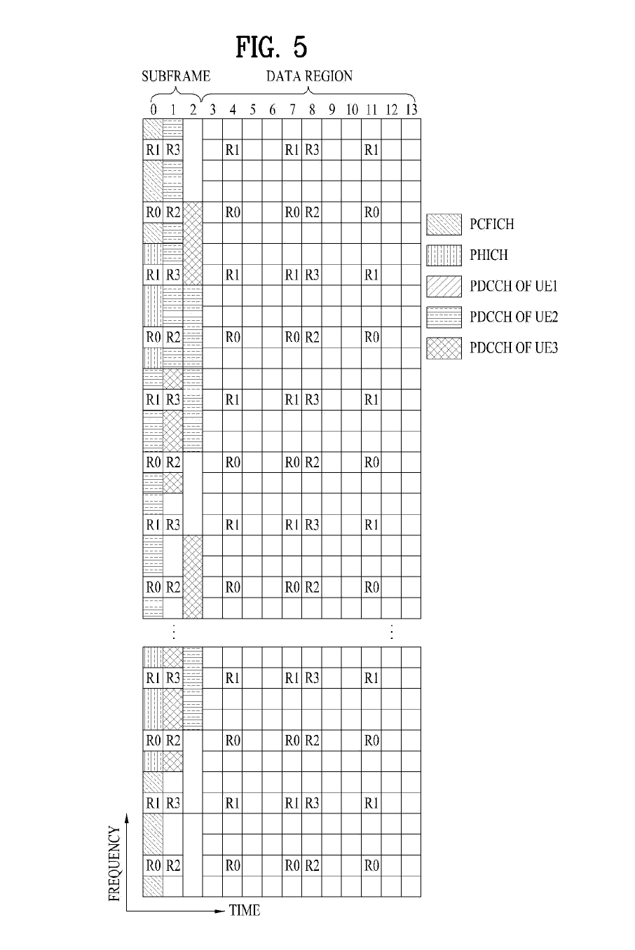

FIG. 5 is a diagram for showing an example of a control channel included in a control region of a single subframe in a DL radio frame.

Referring to FIG. 5, a subframe consists of 14 OFDM symbols. According to a subframe configuration, the first 1 to 3 OFDM symbols are used for a control region and the other 13˜11 OFDM symbols are used for a data region. In the diagram, R1 to R4 may indicate a reference signal (hereinafter abbreviated RS) or a pilot signal for an antenna 0 to 3. The RS is fixed as a constant pattern in the subframe irrespective of the control region and the data region. The control channel is assigned to a resource to which the RS is not assigned in the control region and a traffic channel is also assigned to a resource to which the RS is not assigned in the data region. The control channel assigned to the control region may include a physical control format indicator channel (PCFICH), a physical hybrid-ARQ indicator channel (PHICH), a physical downlink control channel (PDCCH), and the like.

The PCFICH (physical control format indicator channel) informs a user equipment of the number of OFDM symbols used for the PDCCH on every subframe. The PCFICH is situated at the first OFDM symbol and is configured prior to the PHICH and the PDCCH. The PCFICH consists of 4 resource element groups (REG) and each of the REGs is distributed in the control region based on a cell ID (cell identity). One REG consists of 4 resource elements (RE). The RE may indicate a minimum physical resource defined as ‘one subcarrier×one OFDM symbol’. The value of the PCFICH may indicate the value of 1 to 3 or 2 to 4 according to a bandwidth and is modulated into a QPSK (quadrature phase shift keying).

The PHICH (physical HARQ (hybrid-automatic repeat and request) indicator channel) is used for carrying HARQ ACK/NACK for an UL transmission. In particular, the PHICH indicates a channel to which DL ACK/NACK information is transmitted for UL HARQ. The PHICH consists of a single REG and is scrambled cell-specifically. The ACK/NACK is indicated by 1 bit and modulated into BPSK (binary phase shift keying). The modulated ACK/NACK is spread into a spread factor (SF) 2 or 4. A plurality of PHICHs, which are mapped to a same resource, composes a PHICH group. The number of PHICH, which is multiplexed by the PHICH group, is determined according to the number of spreading code. The PHICH (group) is repeated three times to obtain diversity gain in a frequency domain and/or a time domain.

The PDCCH (physical DL control channel) is assigned to the first n OFDM symbol of a subframe. In this case, the n is an integer more than 1 and indicated by the PCFICH. The PDCCH consists of at least one CCE. The PDCCH informs each of user equipments or a user equipment group of an information on a resource assignment of PCH (paging channel) and DL-SCH (downlink-shared channel), which are transmission channels, an uplink scheduling grant, HARQ information and the like. The PCH (paging channel) and the DL-SCH (downlink-shared channel) are transmitted on the PDSCH. Hence, an eNode B and the user equipment transmit and receive data via the PDSCH in general except a specific control information or a specific service data.

Information on a user equipment (one or a plurality of user equipments) receiving data of PDSCH, a method of receiving and decoding the PDSCH data performed by the user equipment, and the like is transmitted in a manner of being included in the PDCCH. For instance, assume that a specific PDCCH is CRC masked with an RNTI (radio network temporary identity) called “A” and an information on data transmitted using a radio resource (e.g., frequency position) called “B” and a DCI format i.e., a transmission form information (e.g., a transport block size, a modulation scheme, coding information, and the like) called “C” is transmitted via a specific subframe. In this case, the user equipment in a cell monitors the PDCCH using the RNTI information of its own, if there exist at least one or more user equipments having the “A” RNTI, the user equipments receive the PDCCH and the PDSCH, which is indicated by the “B” and the “C”, via the received information on the PDCCH.

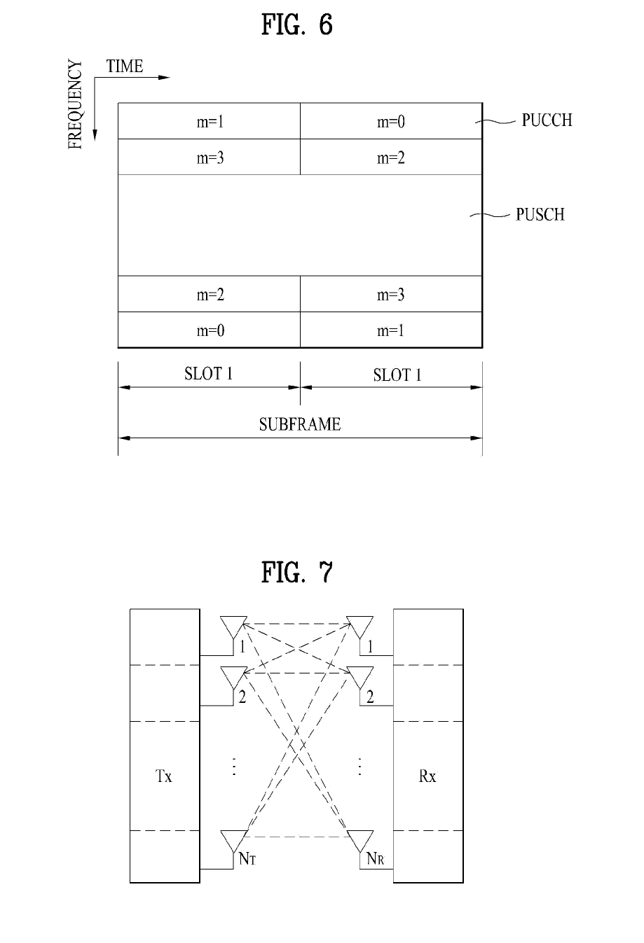

FIG. 6 is a diagram for a structure of an uplink subframe used in LTE system.

Referring to FIG. 6, an UL subframe can be divided into a region to which a physical uplink control channel (PUCCH) carrying control information is assigned and a region to which a physical uplink shared channel (PUSCH) carrying a user data is assigned. A middle part of the subframe is assigned to the PUSCH and both sides of a data region are assigned to the PUCCH in a frequency domain. The control information transmitted on the PUCCH includes an ACK/NACK used for HARQ, a CQI (channel quality indicator) indicating a DL channel status, an RI (rank indicator) for MIMO, an SR (scheduling request) corresponding to an UL resource allocation request, and the like. The PUCCH for a single UE uses one resource block, which occupies a frequency different from each other in each slot within a subframe. In particular, 2 resource blocks assigned to the PUCCH are frequency hopped on a slot boundary. In particular, FIG. 6 shows an example that the PUCCHs satisfying conditions (e.g., m=0, 1, 2, 3) are assigned to a subframe.

In the following description, MIMO system is explained. The MIMO (multiple-input multiple-output) is a method using a plurality of transmitting antennas and a plurality of receiving antennas. The efficiency in transmitting and receiving data may be enhanced by the MIMO. In particular, by using a plurality of the antennas at a transmitting end or a receiving end in a radio communication system, it may be able to increase a capacity and enhance performance. In the following description, the MIMO may be called a ‘multi antenna’.

In the multiple antenna technology, it may not depend on a single antenna path to receive a whole message. Data is completed in a manner of combining data fragments received from many antennas in one place in the multiple antenna technology instead. When the multiple antenna technology is used, a data transmission speed may be enhanced in a cell area having a specific size or a system coverage may be enlarged while a specific data transmission speed is secured. And, this technology is widely used in a mobile communication terminal, a relay station, and the like. According to the multiple antenna technology, a throughput limitation of a single antenna used by a conventional technology in a mobile communication can be overcome.

A block diagram of a general multi-antenna (MIMO) communication system is depicted in FIG. 7.

N_{T} number of transmitting antenna is installed in a transmitting end and N_{R} number of receiving antenna is installed in a receiving end. As described in the above, in case that both the transmitting end and the receiving end use plural number of antennas, a theoretical channel transmission capacity is increased compared to a case that the plural number of antennas are only used for either the transmitting end or the receiving end. The increase of the channel transmission capacity is proportional to the number of antenna. Thus, a transfer rate is enhanced and frequency efficiency is enhanced. If a maximum transfer rate is represented as Rₒ in case of using a single antenna, the transfer rate using multiple antennas can be theoretically increased as much as the maximum transfer rate Rₒ multiplied by a rate of increase Rᵢ, as shown in the following Equation 1. In this case, the Rᵢ is a smaller value of the N_{T} and the N_{R}.

Rᵢ=min(N_{T},N_{R}) [Equation 1]

For instance, MIMO communication system using 4 transmitting antennas and 4 receiving antennas may be able to theoretically obtain the transfer rate of 4 times of a single antenna system. After the theoretical capacity increase of the multi-antenna system is proved in the mid-90s, various technologies for practically enhancing a data transmission rate have been actively studied up to date and several technologies among them are already reflected in such a various wireless communication standard as a 3rd generation mobile communication, a next generation wireless LAN and the like.

If we look at the research trend related to the multi-antenna until now, many active researches have been performed for such a study of various points of view as a study on information theory related to a multi-antenna communication capacity calculation in various channel environments and multiple access environment, a study on a radio channel measurement and model deduction of the multi-antenna system, a study on a space-time signal processing technology for enhancing a transmission reliability and a transmission rate, and the like.

In case of mathematically modeling a communication method of the multi-antenna system in order to explain it with more specific way, it can be represented as follows. As shown in FIG. 7, assume that there exist N_{T} number of transmitting antenna and N_{R} number of receiving antenna. First of all, if we look into a transmission signal, since the maximum number of information capable of being transmitted is N_{T} in case that there exists N_{T} number of transmitting antenna, transmission information can be represented as a vector in the following Equation 2.

s=└s₁,s₂, . . . , s_{N}_{_{T}}┘^{T} [Equation 2]

Meanwhile, for each of the transmission informations s₁, s₂, . . . s_{N}_{_{T}}, a transmit power may be differentiated according to the each of the transmission informations. In this case, if each of the transmit powers is represented as P₁, P₂, . . . , P_{N}_{_{T}}, transmit power-adjusted transmission information can be represented as a vector in the following Equation 3.

ŝ=[ŝ₁,ŝ₂, . . . , ŝ_{N}_{_{T}}]^{T}=[P₁s₁,P₂s₂, . . . , P_{N}_{_{T}}s_{N}_{_{T}}]^{T} [Equation 3]

And, if ŝ is represented using a diagonal matrix P, it can be represented as a following Equation 4.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Meanwhile, let's consider a case that the NT number of transmission signal x₁, x₂, . . . , x_{N}_{_{T}}, which is practically transmitted, is configured in a manner of applying a weighted matrix W to the adjusted information vectors ŝ. In this case, the weighted matrix performs a role of distributing the transmission information to each of the antennas according to the situation of the transmission channel and the like. The transmission signal x₁, x₂, . . . , x_{N}_{_{T}} can be represented using a vector X in the following Equation 5. In this case, Wᵢⱼ means a weighting between an ith transmitting antenna and jth information. The W is called the weighted matrix or a precoding matrix.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

In general, a physical meaning of a rank of a channel matrix may indicate a maximum number capable of transmitting different information from each other in a given channel. Hence, since the rank of the channel matrix is defined by a minimum number of the numbers of row or column independent from each other, the rank of the matrix is configured not to be greater than the number of the row or the column. For instance, the rank of a channel matrix H (rank (H)) is limited as shown in Equation 6.

rank(H)≦min(N_{T},N_{R}) [Equation 6]

And, let's define each of the informations different from each other, which are transmitted using a multi-antenna technology, as a transport stream or simply a stream. The stream can be named a layer. Then, the number of the transport stream is naturally configured not to be greater than the rank of the channel, which is a maximum number capable of transmitting informations different from each other. Hence, the channel matrix H can be represented as Equation 7 in the following.

# of streams≦rank(H)≦min(N_{T},N_{R}) [Equation 7]

In this case, ‘# of streams’ indicates the number of streams. Meanwhile, in this case, it should be cautious that one stream can be transmitted via more than one antenna.

Various methods making one or more streams correspond to many antennas may exist. These methods can be described in accordance with the kind of the multi-antenna technology in the following description. A case of transmitting one stream via many antennas may be called a space diversity scheme and a case of transmitting many streams via many antennas may be called a space multiplexing scheme. Naturally, a hybrid form of the space diversity and the space multiplexing is also available.

Meanwhile, it is expected that a LTE-A system, which is a standard of a next generation mobile communication system, will support a CoMP (coordinated multi point) transmission method, which is not supported by the conventional standard, to enhance a data transmission rate. In this case, the CoMP transmission method is a transmission method for two or more base stations or cells to communicate with the user equipment in a manner of cooperating with each other to enhance a communication performance between the user equipment situated at a radio shadow zone and the base station (a cell or a sector).

The CoMP transmission method can be classified into a join processing (COMP joint processing, CoMP-JP) method in the form of a cooperative MIMO via data sharing and a coordinated scheduling/beamforming (CoMP-coordinated scheduling/beamforming, CoMP-CS/CB) method.

According to the joint processing (CoMP-JP) method in DL, a user equipment may be able to instantaneously receive data simultaneously from each of the base stations performing the CoMP transmission method. And, a reception performance can be enhanced in a manner of combining the signals received from each of the base stations (Joint Transmission (JT)). And, it is also possible to consider a method of transmitting a data to the user equipment on a specific timing by one of the base stations performing the CoMP transmission method (Dynamic Point Selection (DPS)). On the other hand, according to the coordinated scheduling/beamforming method (CoMP-CS/CB), the user equipment may be able to instantaneously receive data from a single base station via a beamforming.

According to the joint processing (CoMP-JP) method in UL, each of the base stations may be able to simultaneously receive PUSCH signal from the user equipment (Joint Reception (JR)). On the other hand, according to the coordinated scheduling/beamforming method (CoMP-CS/CB), only a single base station may be able to receive the PUSCH. In this case, the decision to use the coordinated scheduling/beamforming method is determined by the coordinating cells (or base stations).

In the following description, an example for a transmission mode of a downlink data channel is described. Currently, 3GPP LTE standard document, specifically, 3GPP TS 36.213 document defines a transmission mode of a downlink data channel as shown in Table 1 in the following. The transmission mode is set to a user equipment via an upper layer signaling, i.e., RRC signaling.

TABLE 1

| Transmission | | Transmission scheme of PDSCH |
|---|---|---|
| mode | DCI format | corresponding to PDCCH |
| Mode 1 | DCI format 1A | Single-antenna port, port 0 |
| | DCI format 1 | Single-antenna port, port 0 |
| Mode 2 | DCI format 1A | Transmit diversity |
| | DCI format 1 | Transmit diversity |
| Mode 3 | DCI format 1A | Transmit diversity |
| | DCI format 2A | Large delay CDD or Transmit diversity |
| Mode 4 | DCI format 1A | Transmit diversity |
| | DCI format 2 | Closed-loop spatial multiplexing or |
| | | Transmit diversity |
| Mode 5 | DCI format 1A | Transmit diversity |
| | DCI format 1D | Multi-user MIMO |
| Mode 6 | DCI format 1A | Transmit diversity |
| | DCI format 1B | Closed-loop spatial multiplexing using a |
| | | single transmission layer |
| Mode 7 | DCI format 1A | If the number of PBCH antenna ports is |
| | | one, Single-antenna port, port 0 is used , |
| | | otherwise Transmit diversity |
| | DCI format 1 | Single-antenna port, port 5 |
| Mode 8 | DCI format 1A | If the number of PBCH antenna ports is |
| | | one, Single-antenna port, port 0 is used , |
| | | otherwise Transmit diversity |
| | DCI format 2B | Dual layer transmission, port 7 and 8 or |
| | | single-antenna port, port 7 or 8 |
| Mode 9 | DCI format 1A | Non-MBSFN subframe: If the number of |
| | | PBCH antenna ports is one; Single- |
| | | antenna port, port 0 is used , otherwise |
| | | Transmit diversity |
| | | MBSFN subframe: Single-antenna port, |
| | | port 7 |
| | DCI format 2C | Up to 8 layer transmission, ports 7-14 or |
| | | single-antenna port, port 7 or 8 |
| Mode 10 | DCI format 1A | Non-MBSFN subframe: If the number of |
| | | PBCH antenna ports is one, Single- |
| | | antenna port, port 0 is used , otherwise |
| | | Transmit diversity |
| | | MBSFN subframe Single-antenna port, |
| | | vport 7 |
| | DCI format 2D | Up to 8 layer transmission, ports 7-14 or |
| | | single-antenna port, port 7 or 8 |

Referring to Table 1, current 3GPP LTE standard document includes a downlink control information (DCI) format, which is defined according to a type of RNTI masked on PDCCH. In particular, in case of a C-RNTI and an SPS C-RNTI, a transmission mode and a DCI format corresponding to the transmission mode (i.e., a transmission mode-based DCI format) are included in the document. And, a DCI format 1A for a Fall-back mode, which is capable of being applied irrespective of each transmission mode, is defined in the document. Table 1 shows an example of a case that a type of RNTI masked on PDCCH corresponds to a C-RNTI.

In Table 1, a transmission mode 10 indicates a downlink data channel transmission mode of the aforementioned CoMP transmission method. For instance, referring to Table 1, if a user equipment performs a blind decoding on PDCCH masked with C-RNTI and then detects a DCI format 2D, the user equipment decodes PDSCH in an assumption that the PDSCH has been transmitted with a multi-layer transmission scheme based on antenna port 7 to 14, i.e., DM-RS. Or, the user equipment decodes PDSCH in an assumption that the PDSCH has been transmitted with a single antenna transmission scheme based on DM-RS antenna port 7 or 8.

On the contrary, if the user equipment performs blind decoding on PDCCH masked with C-RNTI and then detects a DCI format 1A, a transmission mode varies according to whether a corresponding subframe corresponds to an MBSFN subframe. For instance, if the corresponding subframe corresponds to a non-MBSFN subframe, the user equipment decodes PDSCH in an assumption that the PDSCH has been transmitted with a single antenna transmission scheme based on a CRS of an antenna port 0 or a CRS-based transmit diversity scheme. And, if the corresponding subframe corresponds to an MBSFN subframe, the user equipment decodes the PDSCH in an assumption that the PDSCH has been transmitted with a single antenna transmission based on a DM-RS of an antenna port 7.

In the following description, a reference signal is explained in more detail.

In general, a reference signal, which is already known to both a transmitting end and a receiving end, is transmitted from the transmitting end to the receiving end together with data to measure a channel. The reference signal plays not only a role of measuring a channel but also a role of making a demodulation process to be performed in a manner of informing the receiving end of a modulation scheme. The reference signal is classified into a dedicated reference signal (DRS) used for an eNB and a specific user equipment (i.e., UE-specific reference signal) and a cell-specific reference signal used for all UEs in a cell (i.e., common reference signal or cell specific RS (CRS)). The cell-specific reference signal includes a reference signal used for reporting CQI/PMI/RI to an eNB in a manner of measuring CQI/PMI/RI in a user equipment. This sort of reference signal is called a CSI-RS (channel state information-RS).

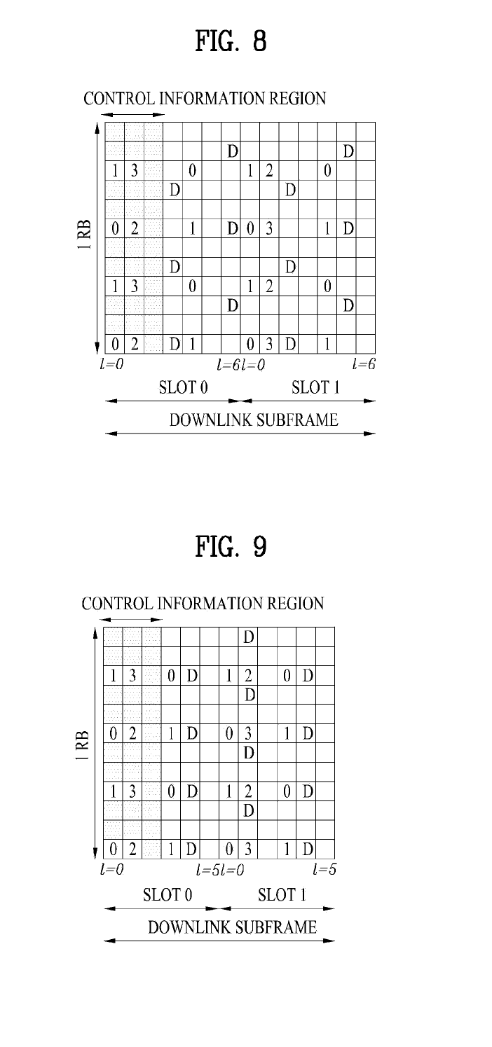

FIG. 8 and FIG. 9 are diagrams of a structure of a reference signal in LTE system supportive of downlink transmission using 4 antennas. In particular, FIG. 8 shows a case of a normal cyclic prefix and FIG. 9 shows a case of an extended cyclic prefix.

Referring to FIG. 8 and FIG. 9, 0 to 3 written on a grid may mean the CRS (common reference signal), which is a cell-specific reference signal, transmitted for the channel measurement and the data demodulation in a manner of corresponding to antenna port 0 to 3, respectively. The cell-specific reference signal CRS can be transmitted to a user equipment via the control information region as well as the data information region.

And, ‘D’ written on the grid may mean a downlink DM-RS (demodulation RS), which is a user-specific RS. The DM-RS supports a single antenna port transmission via the data region, i.e., the PDSCH. The user equipment is signaled whether the DM-RS, which is the user equipment-specific RS, exists or not via an upper layer. FIG. 8 and FIG. 9 show an example of the DM-RS corresponding to an antenna port 5. The DM-RSs corresponding to an antenna port 7 to 14, i.e., total 8 antenna ports, are also defined by 3GPP standard document 36.211.

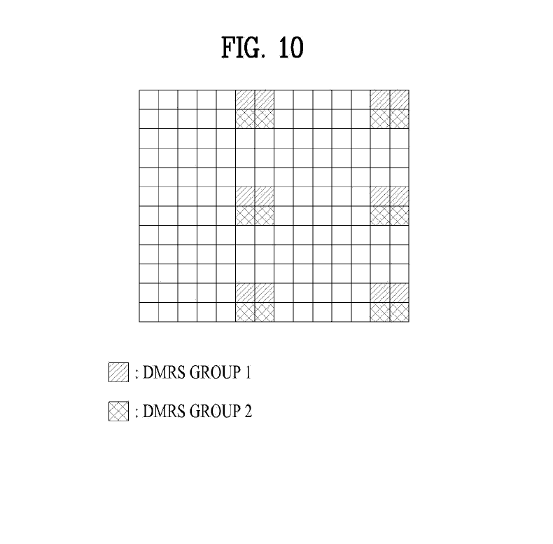

FIG. 10 is a diagram for an example of assigning a downlink DM-RS defined by a current 3GPP standard document.

Referring to FIG. 10, DM-RSs corresponding to antenna ports {7, 8, 11, 13} are mapped to a DM-RS group 1 using a sequence according to an antenna port and DM-RSs corresponding to antenna ports {9, 10, 12, 14} are mapped to a DM-RS group 2 using a sequence according to an antenna port as well.

Meanwhile, the aforementioned CSI-RS is proposed to perform channel measurement for PDSCH irrespective of a CRS. Unlike the CRS, the CSI-RS can be defined by maximum 32 resource configurations different from each other to reduce inter-cell interference (ICI) in a multicell environment.

CSI-RS (resource) configuration varies according to the number of antenna ports. A CSI-RS is configured to be transmitted by different (resource) configurations between neighboring cells. Unlike the CRS, the CSI-RS supports maximum 8 antenna ports. According to 3GPP standard document, total 8 antenna ports (antenna port 15 to antenna port 22) are assigned as the antenna port for the CSI-RS. [Table 2] and [Table 3] list CSI-RS configurations defined in the 3GPP standard. Specifically, [Table 2] lists CSI-RS configurations in the case of a normal CP and [Table 3] lists CSI-RS configurations in the case of an extended CP.

TABLE 2

| | | Number of CSI reference signals configured | | | | | |
|---|---|---|---|---|---|---|---|
| | CSI reference signal | 1 or 2 | | 4 | | 8 | |
| | configuration | (k′, l′) | nₛ mod 2 | (k′, l′) | nₛ mod 2 | (k′, l′) | nₛ mod2 |
| Frame structure | 0 | (9, 5) | 0 | (9, 5) | 0 | (9, 5) | 0 |
| type 1 and 2 | 1 | (11, 2) | 1 | (11, 2) | 1 | (11, 2) | 1 |
| | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame structure | 20 | (11, 1) | 1 | (11, 1) | 1 | (11, 1) | 1 |
| type 2 only | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 3

| | | Number of CSI reference signals configured | | | | | |
|---|---|---|---|---|---|---|---|
| | CSI reference signal | 1 or 2 | | 4 | | 8 | |
| | configuration | (k′, l′) | nₛ mod 2 | (k′, l′) | nₛ mod 2 | (k′, l′) | nₛ mod 2 |
| Frame structure | 0 | (11, 4) | 0 | (11, 4) | 0 | (11, 4) | 0 |
| type 1 and 2 | 1 | (9, 4) | 0 | (9, 4) | 0 | (9, 4) | 0 |
| | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| Frame structure | 16 | (11, 1) | 1 | (11, 1) | 1 | (11, 1) | 1 |
| type 2 only | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

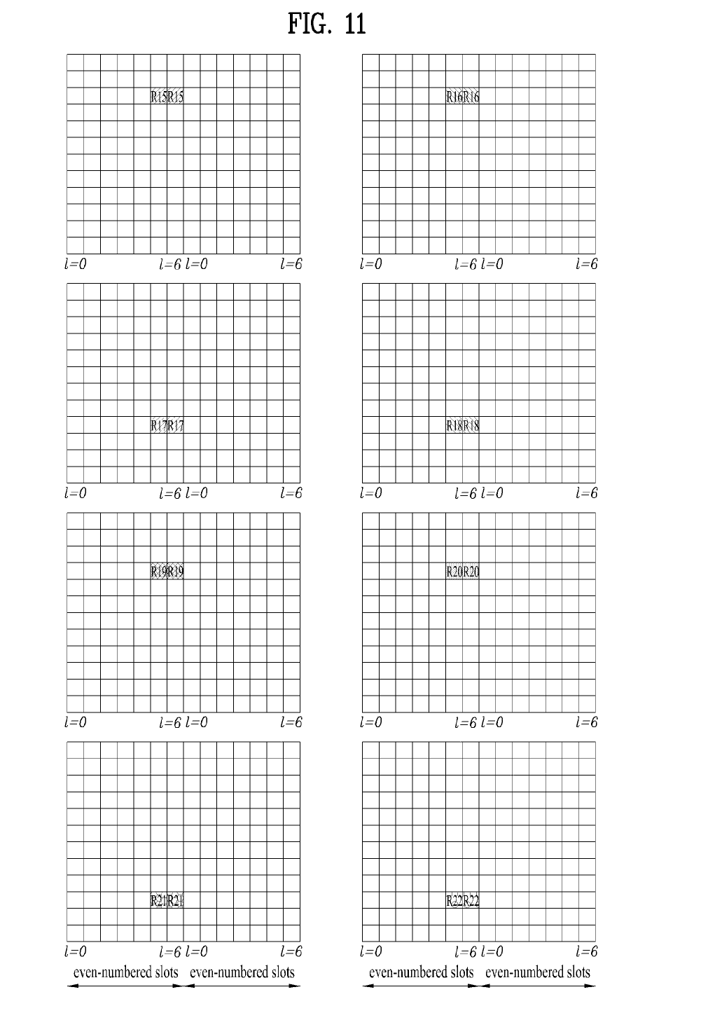

In [Table 2] and [Table 3], (k′,l′) represents an RE index where k′ is a subcarrier index and l′ is an OFDM symbol index. FIG. 11 illustrates CSI-RS configuration #0 of DL CSI-RS configurations defined in the current 3GPP standard.

In addition, CSI-RS subframe configurations may be defined, each by a periodicity in subframes, T_{CSI-RS} and a subframe offset Δ_{CSI-RS}. [Table 4] lists CSI-RS subframe configurations defined in the 3GPP standard.

TABLE 4

| | CSI-RS | CSI-RS |
|---|---|---|
| | periodicity | subframe |
| CSI-RS-SubframeConfig | T_{CSI-RS} | offset Δ_{CSI-RS} |
| I_{CSI-RS} | (subframes) | (subframes) |
| 0-4 | 5 | I_{CSI-RS} |
| 5-4 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

Meanwhile, information about a zero power (ZP) CSI-RS is configured by RRC layer signaling. Particularly, a ZP CSI-RS resource configuration includes zeroTxPowerSubframeConfig and a 16-bit bitmap, zeroTxPowerResourceConfigList. zeroTxPowerSubframeConfig indicates the transmission periodicity and subframe offset of a ZP CSI-RS by I_{CSI-RS} illustrated in [Table 3]. zeroTxPowerResourceConfigList indicates a ZP CSI-RS configuration. The elements of this bitmap indicate the respective configurations written in the columns for four CSI-RS antenna ports in [Table 1] or [Table 2]. A typical CSI-RS other than the ZP CSI-RS is referred to as a non-zero power (NZP) CSI-RS.

When the above-described CoMP scheme is applied, a plurality of CSI-RS configurations may be configured for the UE through RRC layer signaling. Each CSI-RS configuration is defined as shown in [Table 5]. As can be appreciated with reference to [Table 5], each CSI-RS configuration includes information about a CRS with which quasi co-location (QCL) can be assumed.

TABLE 5
CSI-RS-ConfigNZP information elements

-- ASN1START

| | |
|---|---|
| CSI-RS-ConfigNZP-r11 ::= | SEQUENCE { |

| | |
|---|---|
| csi-RS-ConfigNZPId-r11 | CSI-RS-ConfigNZPId-r11, |
| antennaPortsCount-r11 | ENUMERATED {an1, an2, an4, an8}, |
| resourceConfig-r11 | INTEGER (0..31), |
| subframeConfig-r11 | INTEGER (0..154), |
| scramblingIdentity-r11 | INTEGER (0..503), |
| qcl-CRS-Info-r11 | SEQUENCE { |

| | |
|---|---|
| qcl-ScramblingIdentity-r11 | INTEGER (0..503), |
| crs-PortsCount-r11 | ENUMERATED {n1, n2, n4, spare1}, |
| mbsfn-SubframeConfigList-r11 | CHOICE { |

| | |
|---|---|
| release | NULL, |
| setup | SEQUENCE { |

| | |
|---|---|
| subframeConfigList | MBSFN-SubframeConfigList |
| } | |

| | | |
|---|---|---|
| } | OPTIONAL | -- Need ON |
| } | OPTIONAL, | -- Need OR |
| ... | | |
| } | | |
| -- ASN1STOP | | |

Meanwhile, a PDSCH RE mapping and quasi co-location indicator (PQI) field has been defined in DCI format 2D in a recent 3GPP LTE-A standard for transmission mode 10, which is PDSCH transmission of the CoMP scheme. Specifically, the PQI field is defined by 2 bits and indicates a total of four states as shown in [Table 6] below. Information indicated by each state is a parameter set for receiving a PDSCH of the CoMP scheme and detailed values thereof are pre-signaled by higher layers. That is, for [Table 6], a total of four parameter sets may be semi-statically signaled through an RRC layer signal and the PQI field of DCI format 2D dynamically indicates one of the four parameter sets.

TABLE 6

| Value of ‘PDSCH RE | |
|---|---|
| Mapping and | |
| Quasi-Co-Location | |
| Indicator’ field | Description |
| ‘00’ | Parameter set 1 configured by higher layers |
| ‘01’ | Parameter set 2 configured by higher layers |
| ‘10’ | Parameter set 3 configured by higher layers |
| ‘11’ | Parameter set 4 configured by higher layers |

Information included in each parameter set includes at least one of number of CRS antenna ports (crs-PortsCount), a CRS frequency shift (crs-FreqShift), MBSFN subframe configuration (mbsfn-SubframeConfigList), ZP CSI-RS configuration (csi-RS-ConfigZPld), a PDSCH start symbol (pdsch-Start), and QCL information of an NZP CSI-RS.

In the following, QCL (Quasi Co-Location) between antenna ports is explained.

QCL between antenna ports indicates that all or a part of large-scale properties of a signal (or a radio channel corresponding to a corresponding antenna port) received by a user equipment from a single antenna port may be identical to large-scale properties of a signal (or a radio channel corresponding to a corresponding antenna port) received from a different single antenna port. In this case, the larger-scale properties may include Doppler spread related to frequency offset, Doppler shift, average delay related to timing offset, delay spread and the like. Moreover, the larger-scale properties may include average gain as well.

According to the aforementioned definition, a user equipment cannot assume that the large-scale properties are identical to each other between antenna ports not in the QCL, i.e., NQCL (Non Quasi co-located) antenna ports. In this case, the user equipment should independently perform a tracking procedure to obtain frequency offset, timing offset and the like according to an antenna port.

On the contrary, the user equipment can perform following operations between antenna ports in QCL.

1) The user equipment can identically apply power-delay profile for a radio channel corresponding to a specific antenna port, delay spread, Doppler spectrum and Doppler spread estimation result to a Wiener filter parameter, which is used for estimating a channel for a radio channel corresponding to a different antenna port, and the like.

2) After obtaining time synchronization and frequency synchronization for the specific antenna port, the user equipment can apply identical synchronization to a different antenna port as well.

3) The user equipment can calculate an average value of RSRP (reference signal received power) measurement values of each of the antenna ports in QCL to obtain average gain.

For instance, having received DM-RS based downlink data channel scheduling information (e.g., DCI format 2C) via PDCCH (or E-PDCCH), the user equipment performs channel estimation for PDSCH via a DM-RS sequence indicated by the scheduling information and may be then able to perform data demodulation.

In this case, if a DM-RS antenna port used for demodulating a downlink data channel and a CRS antenna port of a serving cell are in QCL, when the user equipment performs a channel estimation via the DM-RS antenna port, the user equipment can enhance reception capability of the DM-RS based downlink data channel in a manner of applying large-scale properties of a radio channel estimated from a CRS antenna port of the user equipment as it is.

Similarly, if a DM-RS antenna port used for demodulating a downlink data channel and a CSI-RS antenna port of a serving cell are in QCL, when the user equipment perform a channel estimation via the DM-RS antenna port, the user equipment can enhance reception capability of the DM-RS based downlink data channel in a manner of applying large-scale properties of a radio channel estimated from a CSI-RS antenna port of the serving cell as it is.

Meanwhile, when the eNB transmits a DL signal in transmission mode 10 of the CoMP scheme in an LTE system, the eNB may be defined to configure the UE with one of QCL type A and QCL type B through higher layer signaling.

In QCL type A, the UE assumes that antenna ports of a CRS, a CSI-RS, and a DM-RS are QCL with respect to large-scale properties except for average gain. QCL type A means that physical channels and signals are transmitted in the same node (point).

In QCL type B, the UE assumes that antenna ports of a DM-RS and a specifically indicated CSI-RS are QCL with respect to large-scale properties except for average gain. Particularly, QCL type B is defined to configure up to four QCL modes for each UE by a higher layer message so as to perform CoMP transmission such as DPS or JT and a QCL mode to be used for DL signal reception is dynamically indicated to the UE by DCI. This information is defined by qcl-CSI-RS-ConfigNZPId among parameter sets of the PQI field.

DPS transmission in the case of QCL type B will now be described in more detail.

First, it is assumed that node #1 including N₁ antenna ports transmits CSI-RS resource #1 and node #2 including N₂ antenna ports transmits CSI-RS resource #2. In this case, CSI-RS resource #1 is included in parameter set #1 of the PQI and CSI-RS resource #2 is included in parameter set #2 of the PQI. Furthermore, the eNB signals parameter set #1 and parameter set #2 to a UE located within the common coverage of node #1 and node #2 through higher layer signaling.

Next, the eNB may perform DPS by configuring, using DCI, parameter set #1 during data (i.e. PDSCH) transmission to the UE through node #1 and parameter set #2 during data transmission to the UE through node #2. If parameter set #1 of the PQI is configured for the UE through the DCI, the UE may assume that CSI-RS resource #1 is QCL with a DM-RS and, if parameter set #2 of the PQI is configured for the UE, the UE may assume that CSI-RS resource #2 is QCL with the DM-RS.

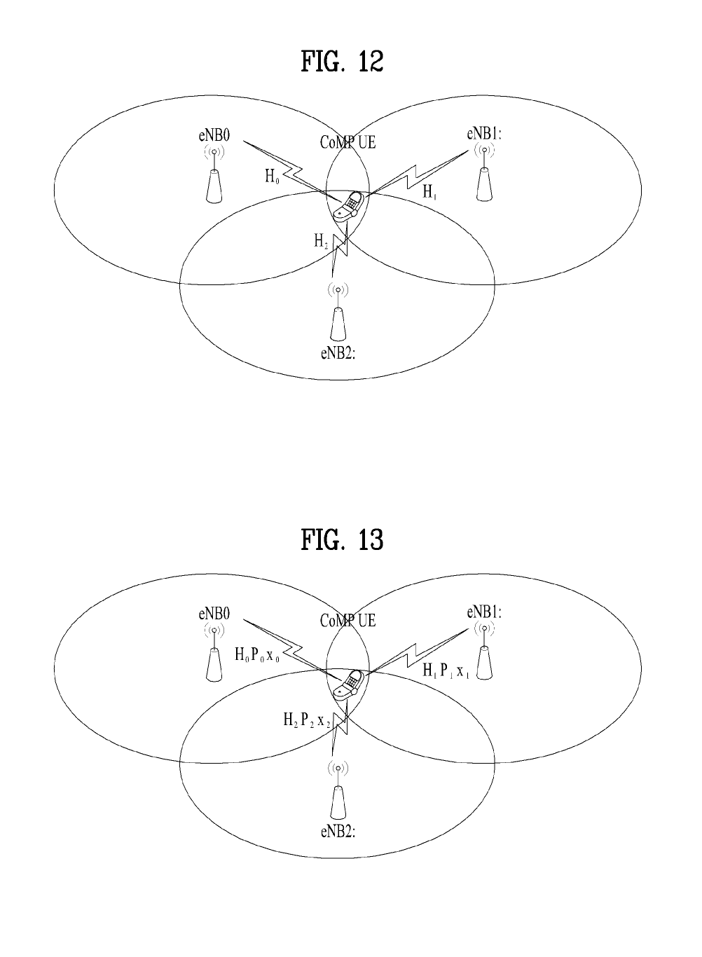

Hereinafter, a CoMP joint transmission (JT) scheme will be described in more detail. In the JT scheme in a CoMP transmission mode, a plurality of transmission points simultaneously transmits data to one UE through cooperation. FIG. 12 illustrates an example of signal transmission using a JT scheme through cooperation between three transmission points.

Although the transmission points are located at different geographical positions in FIG. 12 by way of example, the present invention may be applied to the case in which the transmission points transmit signals at the same position in different transmission directions. A UE recognizes a transmission point as a point at which a configured CSI-RS is transmitted. Accordingly, if a plurality of CSI-RSs is configured for the UE, transmission points that transmit the CSI-RSs may be located at different positions or the same position.

If N transmission points cooperatively transmit signals to a UE, the UE receives a signal expressed as follows.

$$\begin{matrix}y = {H}_{c} {P}_{c} x + n \\ = [ \begin{matrix}{H}_{0} & {H}_{1} & … & {H}_{N - 1}\end{matrix} ] {P}_{c} x + n\end{matrix} \qquad [ Equation 8 ]$$

In Equation 8, Hᵢ denotes a MIMO channel matrix between an i-th transmission point and the UE. The number of rows of Hᵢ corresponds to the number of reception antennas of the UE and the number of columns of Hᵢ corresponds to the number aᵢ of transmission antennas of the i-th transmission point. Further, x and y denote a transmitted data vector and a received signal vector, respectively, and n represents a noise and interference signal vector. P_{c} denotes a composite precoding matrix. The number of rows of P_{c} is given as Σaᵢ which is the sum of the numbers of transmission antennas of all cooperative transmission points. The number of columns of P_{c} is equal to the number L of transmission layers.

JT is a scheme of transmitting a precoded transmission signal P_{c}x on a composite channel H_{c}. In the JT scheme, CSI feedback is performed such that the UE reports the composite precoding matrix P_{c} of Equation 8 that maximizes throughput of a composite MIMO channel and a CQI at the composite precoding matrix P_{c} to an eNB.

The composite precoding matrix P_{c} reported in a CSI feedback process may be limited to matrices in a predefined codebook in consideration of feedback overhead. In an LTE system, the number of transmission antennas of each transmission point is one of 1, 2, 4, and 8 and a codebook is predefined for 2, 4, and 8 antenna ports. In the JT scheme, a codebook for Σaᵢ antenna ports should be newly defined in order to feed back the composite precoding matrix P_{c} at one time. However, even when cooperative transmission of up to three transmission points is considered, Σaᵢ can indicate many values so that the number of required codebooks increases and thus complexity increases.

To overcome this problem, the composite precoding matrix P_{c} is divided into precoding matrices Pᵢ each applied to a transmission antenna of an i-th transmission point as indicated in Equation 9 and each precoding matrix Pᵢ (i=0, . . . , N−1) and a CQI at the precoding matrix Pᵢ are reported as CSI feedback.

$$\begin{matrix}y = {H}_{c} {P}_{c} x + n \\ = [ \begin{matrix}{H}_{0} & {H}_{1} & … & {H}_{N - 1}\end{matrix} ] [ \begin{matrix}{P}_{0} \\ {P}_{1} \\ ⋮ \\ {P}_{N - 1}\end{matrix} ] x + n \\ = {\sum }_{i = 0}^{N - 1} {H}_{i} {P}_{i} x + n\end{matrix} \qquad [ Equation 9 ]$$

Pᵢ which is a precoding matrix applied to a transmission antenna of an i-th transmission point may be fed back using an existing codebook for 2, 4, and 8 antenna ports. However, since an existing codebook for aᵢ antenna ports supports only up to aᵢ layers, a feedback rank selectable in feeding back each precoding matrix Pᵢ using the existing codebook for aᵢ antenna ports is limited to min(aᵢ).

For example, when transmission point A having two antennas and transmission point B having four antennas transmit signals to a UE having 8 reception antennas using the JT scheme, a maximum of 6 layers can be transmitted theoretically. However, since the UE feeds back a precoding matrix to be used for transmission point A in a codebook for two antenna ports and feeds back a precoding matrix to be used for transmission point B in a codebook for four antenna ports, a feedback rank for the JT scheme is limited to min(2,4). Consequently, to maximize spatial multiplexing (SM) gain that can be obtained from Σaᵢ antenna ports, the existing codebook needs to be modified. As a typical example, a precoding matrix that enables transmission of aᵢ or more layers should be added to a codebook for aᵢ antenna ports.

As a method for maximizing SM gain while using the existing codebook, the following JT scheme of Equation 10 is considered.

$$\begin{matrix}y = {H}_{c} {P}_{c} x + n \\ = [ \begin{matrix}{H}_{0} & {H}_{1} & … & {H}_{N - 1}\end{matrix} ] [ \begin{matrix}{P}_{0} & 0 & … & 0 \\ 0 & {P}_{1} & … & 0 \\ ⋮ & ⋮ & & ⋮ \\ 0 & 0 & … & {P}_{N - 1}\end{matrix} ] [ \begin{matrix}{x}_{0} \\ {x}_{1} \\ ⋮ \\ {x}_{N - 1}\end{matrix} ] + n \\ = {\sum }_{i = 0}^{N - 1} {H}_{i} {P}_{i} {x}_{i} + n\end{matrix} \qquad [ Equation 10 ]$$

In Equation 10, xᵢ denotes a data vector transmitted from an i-th transmission point. That is, each transmission point transmits a signal through an independent layer. Therefore, the JT scheme of Equation 10 will be referred to as independent layer joint transmission (ILJT).

FIG. 13 illustrates an example of signal transmission using an ILJT scheme through cooperation between three transmission points.

In FIG. 13, Pᵢ represents a precoding matrix applied to an i-th transmission data vector xᵢ in an i-th transmission point. The number of columns of the precoding matrix Pᵢ is equal to the number of rows of the transmission data vector xᵢ and corresponds to the number Lᵢ of transmission layers transmitted by the i-th transmission point.

For a receiver to successfully detect data, the number Lᵢ of transmission layers should not be greater than the number aᵢ of transmission antennas of the i-th transmission point. Consequently, even though each precoding matrix Pᵢ (i=0, . . . , N−1) is fed back using the existing codebook in a CSI feedback process, the precoding matrix Pᵢ may be fed back up to a maximum rank that can be transmitted in each transmission point. In an ILJT scheme, the sum (L_{c}=ΣLᵢ) of the numbers Lᵢ of transmission layers transmitted in respective transmission points represents the number of composite layers.

Compared to Equation 8 and Equation 9, the ILJT scheme restricts the composite precoding matrix P_{c} except only for a diagonal sub-matrix to a zero matrix. Therefore, although precoding flexibility decreases, the JUT scheme enables feedback of all possible ranks while using the existing codebook, thereby reducing feedback complexity and overhead.

In a data transmission scheme in which only one transmission point transmits data to a UE, such as DPS or coordinated scheduling and coordinated beamforming (CSCB) among CoMP transmission modes, the UE reports a precoding matrix Pᵢ that maximizing throughput of a MIMO channel and a CQI at the precoding matrix Pᵢ to an eNB as CSI feedback for an i-th transmission point in consideration of a reception signal of Equation 11.

y=HᵢPᵢxᵢ+nᵢ (i=0, . . . , N−1) [Equation 11]

In Equation 11, Hᵢ denotes a MIMO channel matrix between the i-th transmission point and the UE, measured from an i-th CSI-RS configured for the UE. The UE also measures a statistical characteristic of nᵢ, typically an auto-covariance matrix from a j-th channel state information interference measurement (CSI-IM) resource configured for the UE. To receive feedback of a downlink channel state between a plurality of transmission points and the UE, the eNB allocates a plurality of CSI processes to the UE. Each CSI process is assigned a CSI-RS resource for MIMO channel measurement and a CSI-IM resource for interference environment measurement.

In the case of cooperative transmission in which two transmission points participate, the eNB allocates CSI process #0 for DL CSI reporting from transmission point #0 and CSI process #1 for DL CSI reporting from transmission point #1. An i-th CSI process is assigned CSI-RS resource #i and CSI-IM resource #i. In this case, upon receiving a signal transmitted by transmission point #0, the UE reflects interference caused by transmission point #1 in measuring the amount of interference by signal transmission of transmission point #1 in CSI-IM resource #1. As a result, since the UE regards the signal transmitted by transmission point #1 in CSI-IM resource #0 as interference, the transmission power and direction of the signal transmitted by transmission point #1 in CSI-IM resource #0 affect the statistical characteristics of interference measured by the UE.

In acquiring each precoding matrix Pᵢ that that maximizes throughput and a CQI corresponding to the precoding matrix Pᵢ in the JUT scheme, the UE calculates the reception quality of each transmission layer, typically, a received signal to interference-plus-noise ratio (SINR) of each transmission layer. In this case, interference between layers should be considered during multi-layer transmission. That is, if two transmission points participate in transmission, transmission layers from transmission point #1 should be considered as interference when the UE calculates a received SINR of a transmission layer from transmission point #0. Although interference caused by a signal transmitted by another transmission point may be reflected in a conventional CSI feedback scheme using Equation 11 by controlling a signal in a CSI-IM resource, it is difficult to accurately reflect the direction and amount of interference.

In the JUT scheme, a transmission signal from transmission point #1 functions as interference during reception of transmission layers from transmission point #0. In this case, the direction of interference is determined by the precoding matrix Pᵢ to be fed back. Therefore, in the conventional CSI feedback scheme using Equation 11, a signal to which the precoding matrix Pᵢ is applied cannot be transmitted in CSI-IM resource #0 through prediction of the precoding matrix Pᵢ to be fed back.

To determine a transmission layer and a modulation and coding scheme (MCS) in the JUT scheme, although the eNB may derive the transmission layer and the MCS using feedback based on a conventional CSI process as in Equation 11, an estimation error increases as described above. Therefore, CSI feedback based on ILJT of Equation 1 needs to be newly defined to maximally derive throughput of the ILJT scheme.

A CSI process for the JUT scheme is assigned a plurality of CSI-RSs and a single CSI-IM. That is, when N transmission points perform cooperative transmission, CSI-RS resource #i (i=0, . . . , N−1) transmitted by an i-th transmission point and one CSI-IM resource for measuring interference from points other than the N cooperative transmission points are assigned. The UE measures Hᵢ in CSI-RS resource #i on the assumption of signal transmission of the JUT scheme of Equation 10, measures statistical characteristics of n in the CSI-IM resource and reports a precoding matrix Pᵢ that maximizes throughput and a CQI corresponding to the precoding matrix Pᵢ to the eNB.

Meanwhile, the number of columns of the feedback precoding matrix Pᵢ corresponds to the number of layers expected to be transmitted by an i-th transmission point and represents the rank of the precoding matrix Pᵢ. The feedback precoding matrix Pᵢ is selected from a codebook and is expressed as a PMI and an RI. Therefore, N RIs and N PMIs are fed back in an ILJT CSI process.

An RI which is fed back for a general CSI process has a value between 1 and Lₘₐₓ. However, if an RI which is fed back in the ILJT scheme has a value of 1 or more, the UE should consider only the case in which each transmission point transmits a minimum of one layer. In the ILJT scheme of N=2, if transmission point #0 transmits two layers and transmission point #1 transmits zero layers according to a channel environment, this does not create interference and thus throughput can be maximized. Therefore, it is desirable that the rank which is fed back have a value between 0 and Lₘₐₓ. If the feedback RI is 0, this means that the UE requests that a corresponding transmission point not transmit any data.

In this case, N RIs and N PMIs may be fed back in an ILJT CSI process and RI #i which is fed back based on CSI-RS resource #i may have a value between 0 and L_{max,i}. When RI #i is 0, PMI #i which is fed back based on CSI-RS resource #i is not fed back or is fed back in a null state.

As described above, N RIs and N PMIs are fed back in the ILJT CSI process. The sum of the feedback RIs (RI_{c}=ΣRIᵢ) is equal to or larger than 1. If the UE is capable of receiving a maximum of Lₘₐₓ layers according to the number of antennas of the UE or the capability of a radio frequency (RF) stage, the sum of the RIs satisfies RI_{c}=ΣRIᵢ≦Lₘₐₓ.

A data unit to which an MCS and a HARQ process are independently applied is referred to as a codeword. While an independent codeword for each transmission layer may be individually transmitted in a MIMO transmission scheme, the number of transmitted codewords increases as the number of transmission layers increases. Therefore, the amount of control information increases. To mitigate theses problems, one codeword is transmitted for 1-layer transmission and two codewords are transmitted for n-layer transmission (n>2) in an LTE system. When two codewords are transmitted through n (n>2) layers, one codeword is mapped to a plurality of layers according to a preset codeword-to-layer mapping scheme. The codeword-to-layer mapping scheme represents to which layer each codeword is mapped.

In the LTE system, codeword #0 is mapped to layers having lower indexes and codeword #1 is mapped to layers having higher indexes. If the number of transmission layers is an even number, the number of layers mapped to codeword #0 is equal to the number of layers mapped to codeword #1. If the number of transmission layers is an odd number, the number of layers mapped to codeword #1 is greater than the number of layers mapped to codeword #0 by one.

In a CSI process of a legacy LTE system, a CQI for each codeword is calculated and fed back. That is, for a rank of 1, only a CQI for codeword #0 is fed back and, for a rank larger than 1, a CQI for codeword #0 and a CQI for codeword #1 are individually fed back.

Therefore, N RIs and N PMIs are fed back in the ILJT CSI process. In addition, for RI_{c} of 1, only CQI #0 for codeword #0 is fed back and, for RI_{c} larger than 1, CQI #0 for codeword #0 and CQI #1 for codeword #1 are individually fed back. To calculate CQI #0 and CQI #1 for RI_{c} larger than 1, a codeword-to-layer mapping relationship should be defined.

In the ILJT scheme, the following two codeword-to-layer mapping schemes may be considered.

Scheme 1) In consideration of RI #i and PMI #i to be fed back, the index of a first layer transmitted by an i-th transmission point is next to the index of a layer used in an (i−1)-th transmission point. That is, if the sum of feedback RIs is RI_{c}=ΣRIᵢ, layers are uniformly indexed from 0 to RI_{c}−1 and a low-layer index is first allocated to a transmission point of a low index. Codeword #0 is mapped to low-index layers and codeword #1 is mapped to high-index layers. If RI_{c} is an even number, the number of layers mapped to codeword #0 is equal to the number of layers mapped to codeword #1 and, if RI_{c} is an odd number, the number of layers mapped to codeword #1 is larger than the number of layers mapped to codeword #0 by one.

For example, in a situation in which two transmission points cooperate with each other, if each of feedback RI #0 and RI #1 is 2, the UE calculates CQI #0 and CQI #1 on the assumption that the first codeword is transmitted through two layers transmitted by the first transmission point and the second codeword is transmitted through two layers transmitted by the second transmission point.

Scheme 2) To map layers transmitted to each transmission point to codeword #0 and codeword #1 as equally as possible, if a feedback rank for an i-th transmission point is RIᵢ, layers transmitted by a corresponding transmission point are indexed from 0 to RIᵢ−1. Codeword #0 is mapped to lower-index layers and codeword #1 is mapped to higher-index layers.

New indexes starting from 0 are assigned only to transmission points for which RIᵢ is an odd number. If RIᵢ is an odd number and an assigned index is an even number, the number of layers mapped to codeword #1 is larger than the number of layers mapped to codeword #0 by one. If RIᵢ is an odd number and the assigned index is an odd number, the number of layers mapped to codeword #0 is larger than the number of layers mapped to codeword #1 by one.

For example, in a situation in which two transmission points cooperate with each other, if each of feedback RI #0 and RI #1 is 2, the UE calculates CQI #0 and CQI #1 on the assumption that the first codeword is transmitted through the first layer transmitted by each transmission point and the second codeword is transmitted through the second layer transmitted by each transmission point.

Additionally, in the ILJT CSI process in which N CSI-RS resources and one CSI-IM resource are assigned, N RIs, N PMIs, and a CQI may be fed back for each transmission point. CQI(i) for an i-th transmission point is a CQI for layers transmitted by an i-th transmission point.

If RI(i) for the i-th transmission point is 0, PMI(i) and CQI(i) are not fed back or are fed back with a null value. If RI(i) is 1, CQI(i) corresponds to a CQI of a layer transmitted by the i-th transmission point. If RI(i) is larger than 1, CQI(i) includes two CQIs, i.e. CQI #0(i) for codeword #0 and CQI #1(i) for codeword #1 in consideration of codeword-to-layer mapping of the legacy LTE system.

Hereinbelow, QCL information that should be assumed by the UE and a PDSCH RE mapping scheme when a DM-RS based PDSCH is transmitted in the above-described ILJT scheme are proposed. Although only a PDCCH will be described below as a control channel for convenience, it is apparent that the same description is also applicable to an enhanced PDCCH (EPDCCH). The EPDCCH is a new control channel that is introduced to apply a MIMO scheme and an intercell cooperative communication scheme to a multi-node environment and is transmitted in a data region (hereinafter, referred to as a PDSCH region) rather than an existing control region (hereinafter, a PDCCH region). The EPDCCH is transmitted and received based on a DM-RS rather than an existing cell-specific RS (CRS).

If a signal is transmitted through two or more layers in a single user MIMO (SU-MIMO) transmission scheme of the LTE system, two transport blocks (TBs) are transmitted to apply interference cancellation between the layers. If one of the two TBs is successfully decoded, the UE may delete a transmission signal of the TB from a received signal and decode another TB in an environment in which interference between the layers is cancelled. To this end, DCI of SU-MIMO includes MCS information, a new data indicator (NDI), and a redundancy version (RV) for each of TB1 and TB2.

FIG. 14 illustrates a structure of a PDCCH in an LTE system. Particularly, FIG. 14 illustrates an example of DCI of SU-MIMO.

Referring to FIG. 14, information transmitted through the PDCCH broadly includes DCI and a cyclic redundancy check (CRC) masked by a C-RNTI. The DCI includes a field for resource allocation (RA), HARQ process, transmission power control (TPC), and layer mapping information (LMI) and a field for transmitting MCS, NDI, and RV information of each TB.

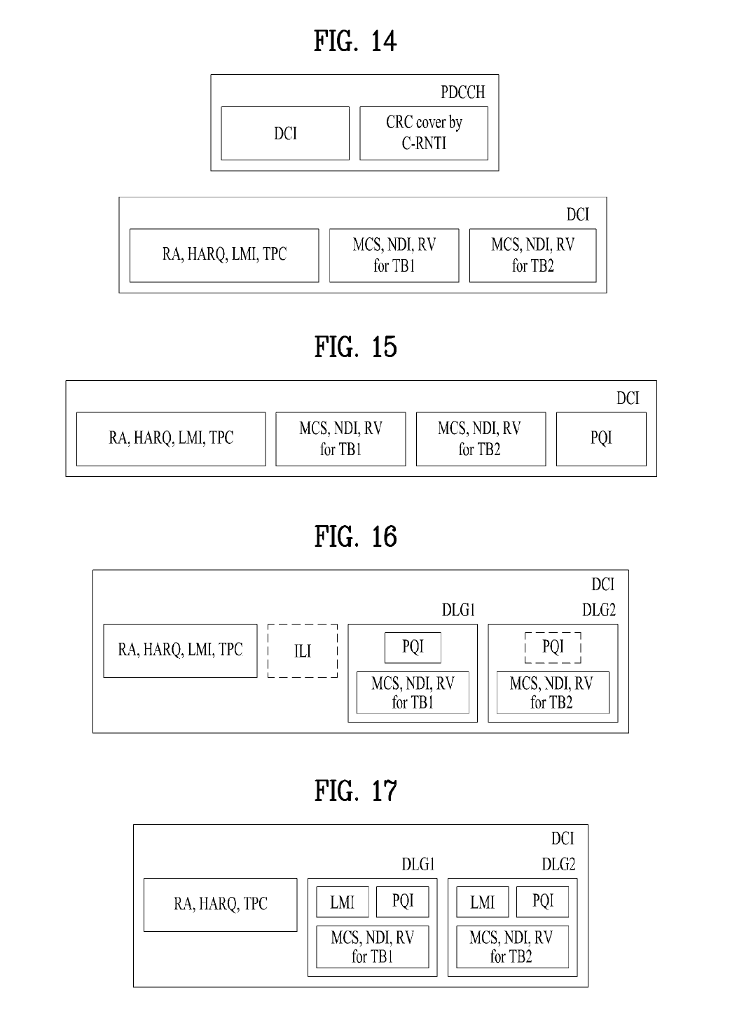

FIG. 15 illustrates another structure of a PDCCH in an LTE system.

Referring to FIG. 15, the DCI further includes the above-described PQI field for supporting DL CoMP transmission, i.e. transmission mode 10.

As in the ILJT scheme, if a different transmission point for each specific layer transmits a signal, a UE should receive, from an eNB, information enabling detection of a representative RS (e.g. a CSI-RS or CRS) capable of specifying a transmission point transmitting the signal with respect to each layer. In addition, the UE needs to be configured to receive a DM-RS based PDSCH by applying a QCL assumption between the representative RS of the transmission point and a DM-RS transmitted through a layer corresponding to the transmission point.

If information for the QCL assumption is provided, an estimate of large-scale properties of a radio channel from an RS other than a DM-RS, for example, from an RS having a relatively high density such as a CSI-RS or a CRS, transmitted by a transmission point transmitting a signal through a specific layer is used during channel estimation through a DM-RS of a PDSCH of ILJT, so that reception performance of the DM-RS based PDSCH can be improved.

Accordingly, the present invention proposes that a total of layers as shown in FIG. 15 be divided into two or more groups (hereinafter, data layer group (DLGs)) and PQI information for each DLG and other information (e.g., at least one of LMI, MCS, NDI, and RV) associated with the DLG be configured in the fields of DCI.

More specifically, existing information, such as MCS, NDI, and RV, which is independently configured for each TB may be configured for each DLG as information about a data stream of each DLG such as MCS, NDI, and RV. In this case, each DLG may always be limited to linkage to a single TB. Then, the information such as MCS, NDI, and RV may be interpreted as being configured for each TB. That is, a specific DLG may be mapped to a specific TB in one-to-one correspondence and this means that information about the data stream such as MCS, NDI, and RV applied to the TB may be configured.

A PQI may be defined as existing 2-bit information for each DLG as shown in [Table 6]. Alternatively, an additional PQI parameter set for the transmission scheme proposed in the present invention may be configured by a higher layer and a specific PQI parameter set may be indicated by a PQI field for each DLG For example, if the UE receives information of CSI-RS #1 and CRS #1 with which a QCL assumption is made and associated information, through the PQI field of DLG1 and receives information of CSI-RS #2 and CRS #2 with which a QCL assumption is made and associated information, through the PQI field of DLG2, the UE detects a DM-RS based PDSCH from a layer corresponding to DLG1 by applying a QCL assumption between a DM-RS antenna port and CSI-RS #1 and between the DM-RS antenna port and CRS #1 and detects a DM-RS based PDSCH from a layer corresponding to DLG2 by applying a QCL assumption between a DM-RS antenna port and CSI-RS #2 and between the DM-RS antenna port and CRS #2.

Characteristically, upon receiving ILJT related specific DCI, the UE needs to receive a DM-RS based PDSCH scheduled through a single HARQ and RA field etc. by applying a different QCL assumption and a different RE mapping rule for each DLG in the case in which the different QCL assumption and the different RE mapping rule are indicated for each DLG although the PDSCH is received in multiple layers. Typically, in the case of CRS rate matching, the multi-layer PDSCH scheduled by a single HARQ and RA field should be received through rate matching to CRS #1 for DLG1 and to CRS #2 for DLG2. Therefore, when the UE receives a PDSCH corresponding to DLG1, the PDSCH and CRS #2 may be received in a collision state and, when the UE receives a PDSCH corresponding to DLG2, the PDSCH and CRS #1 may be received in a collision state.

FIG. 16 illustrates an example of the contents of DCI classified according to DLG according to an embodiment of the present invention.

Referring to FIG. 16, RA, HARQ, LMI, and TPC fields are included in DCI only once as in a conventional scheme and PQI, MCS, NDI, and RV fields are included in each DLG of multiple DLGs.

As shown in FIG. 16, a specific field such as an independent-layer indicator (ILI) is additionally included in the DCI. If the ILI field indicates a specific value such as 0, the DCI is configured like the conventional scheme without the DLG and a PGI field denoted by a dotted box in DLG2 in FIG. 16 is not transmitted. If the ILI field indicates another value, for example, 1, the DCI is configured as an ILJT scheme, i.e. the PQI field is further added to DLG2.

Thus, the ILI field indicates whether the number of DLGs is one or more. For example, if a 2-bit ILI field is configured, this may be extended such that ILI=0 may indicate that there is one DLG as in the conventional scheme, ILI=1 may indicate that there are two DLGs, ILI=2 may indicate there are three DLGs, and ILI=3 may indicate that there are four DLGs.

Desirably, if there are two DLGs, this may be limited to the meaning always indicating that two codewords are transmitted and, if there are n DLGs (n>1), this may be limited to the meaning always indicating that n codewords are transmitted. More desirably, for transmission of n codewords, the codewords are generated from the respective independent TBs. That is, for transmission of three codewords, each of three TBs generates an independent codeword.

In this way, the number of DLGs increases according to a value of the ILI field and thus a valid bit size of DCI varies. The valid bit size may represent meaningful information bit size. While the UE detects the DCI, the total bit size of the DCI may be fixed to a larger value. If the valid bit size is changed to a value smaller than the total bit size, dummy bits corresponding to insufficient bits of the total bit size may be added to the valid bit size, so that the total bit size is always maintained at the fixed value.

If the number of DLGs is limited to one or two, the ILI field may not be included in the DCI and, instead, the number of DLGs may be implicitly indicated by the number of PQI fields in the DCI. For example, if the DCI including only one PQI field is transmitted, this may be interpreted as implicitly indicating ILI=0 in the above example and, if the DCI including two PQI fields is transmitted, this may be interpreted as the ILJT scheme implicitly indicating ILI=1 in the above example.

Alternatively, to prevent the valid bit size of the DCI from varying due to change of the number of PQI fields, the number of PQI fields may always be set to 2. If values of the two PQI fields are equal, this may be interpreted as implicitly indicating ILI=0 and, if the values of the two PQI fields differ, this may be interpreted as the ILJT scheme implicitly indicating ILI=1 in the above example.

For convenience, while the following description will be given on the assumption that the maximum number of DLGs is 2, the present invention is not limited thereto.

If the number of DLGs is indicated as 2, it is desirable that each DLG be limitedly mapped to an independent TB. That is, DLG1 is linked to TB1 and CW1 and CW1 generated from TB1 is transmitted through a layer of DLG1, and DLG2 is linked to TB2 and CW2 and CW2 generated from TB2 is transmitted through a layer of DLG2. This is generalized such that if N>1, DLG n (n=1, . . . , N) is linked to TB #n and CW #n and CW #n generated from TB #n is transmitted through a layer of DLG #n.

According to the current 3GPP standard and FIG. 10, each of DM-RS antenna ports #7 and #8 occupies two REs in one PRB pair and DM-RS antenna ports #7 and #8 are transmitted by overlapping with each other by CDM on the same two REs. Similarly, each of DM-RS antenna ports #9 and #10 occupies two REs in one PRB pair and DM-RS antenna ports #9 and #10 are transmitted overlapping with each other by CDM on the same two REs. In this case, the two REs are located at positions having indexes increased by one subcarrier from transmission positions of DM-RS antenna ports #7 and #8 on the frequency domain. Accordingly, DM-RS antenna ports #7 and #8 maintain orthogonality with DM-RS antenna ports #9 and #10 as an FDM relationship.

DM-RS antenna ports #11 and #12 are transmitted by additionally applying CDM using a length−4 orthogonal code to the transmission positions of DM-RS antenna ports #7 and #8. That is, all of DM-RS antenna ports #7, #8, #11, and #12 are transmitted through CDM on a specific subcarrier. DM-RS antenna ports #13 and #14 are transmitted by additionally applying CDM using a length−4 orthogonal code to the transmission positions of DM-RS antenna ports #9 and #10. That is, all of DM-RS antenna ports #9, #10, #13, and #14 are transmitted through CDM on a specific subcarrier.

Meanwhile, if the number of DLGs is indicated as 2, DM-RS antenna ports belonging to different DLGs are multiplexed through CDM according to a conventional codeword-to-layer mapping rule of [Table 7] shown below. Especially, highlighted parts shown in [Table 7] are problematic.

TABLE 7

| Number | Number of | Codeword-to-layer mapping | |
|---|---|---|---|
| of layers | codewords | i = 0,1, . . . , M_{symb}^{layer} − 1 | |
| 2 | 2 | x⁽⁰⁾(i) = d⁽⁰⁾(i) | M_{symb}^{layer} = M_{symb}⁽⁰⁾ = |
| | | x⁽¹⁾(i) = d⁽¹⁾(i) | M_{symb}⁽¹⁾ |
| 3 | 2 | x⁽⁰⁾(i) = d⁽⁰⁾(i) | M_{symb}^{layer} = M_{symb}⁽⁰⁾ = |
| | | x⁽¹⁾(i) = d⁽¹⁾(2i) | M_{symb}⁽¹⁾/2 |
| | | x⁽²⁾(i) = d⁽¹⁾(2i + 1) | |
| 4 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/2 |
| | | x⁽²⁾(i) = d⁽¹⁾(2i) | |
| | | x⁽³⁾(i) = d⁽¹⁾(2i + 1) | |
| 5 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/3 |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/3 |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/4 |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = |
| | | x⁽¹⁾(i) = d⁽⁰⁾(4i + 1) | M_{symb}⁽¹⁾/4 |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

In consideration of the relationship between RE positions at which each DM-RS antenna port is transmitted and other DM-RS antenna ports transmitted through CDM, the present invention proposes a DM-RS antenna mapping scheme in which a DM-RS antenna port belonging to DLG1 and a DM-RS antenna port belonging to DLG2 are transmitted always through FDM in JUT, for example, a scheme in which RE positions at which each DM-RS antenna port is to be transmitted and/or information about other DM-RS antenna ports transmitted through CDM are determined. Then, even though a separate QCL assumption for each DLG is applied, FDM between antenna ports is preformed without performance degradation caused by different large-scale properties of radio channels of different DLGs.

Additionally, the present invention proposes a DM-RS antenna port mapping scheme in which DM-RS antenna ports in each DLG are always transmitted through CDM. Then, a DM-RS is received by applying the same QCL assumption in each DLG

For the above DM-RS antenna port mapping schemes, the present invention proposes a codeword-to-layer mapping rule as shown in [Table 8]. Especially, in Table 8, highlighted parts represent changed parts as compared with [Table 7].

TABLE 8

| Number | Number of | Codeword-to-layer mapping | |
|---|---|---|---|
| of layers | codewords | i = 0,1, . . . , M_{symb}^{layer} − 1 | |
| 2 | 2 | x⁽⁰⁾(i) = d⁽⁰⁾(i) | M_{symb}^{layer} = M_{symb}⁽⁰⁾ = |
| | | x⁽¹⁾(i) = d⁽¹⁾(i) | M_{symb}⁽¹⁾ |
| 3 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾ |
| | | x⁽²⁾(i) = d⁽¹⁾(i) | |
| 4 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/2 |
| | | x⁽²⁾(i) = d⁽¹⁾(2i) | |
| | | x⁽³⁾(i) = d⁽¹⁾(2i + 1) | |
| 5 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/3 |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/4 |
| | | x⁽²⁾(i) = d⁽¹⁾(4i) | |
| | | x⁽³⁾(i) = d⁽¹⁾(4i + 2) | |
| | | x⁽⁴⁾(i) = d⁽¹⁾(4i + 3) | |
| | | x⁽⁵⁾(i) = d⁽¹⁾(4i + 4) | |
| 7 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/4 |
| | | x⁽²⁾(i) = d⁽¹⁾(4i) | |
| | | x⁽³⁾(i) = d⁽¹⁾(4i + 2) | |
| | | x⁽⁴⁾(i) = d⁽¹⁾(4i + 3) | |
| | | x⁽⁵⁾(i) = d⁽¹⁾(4i + 4) | |
| | | x⁽⁶⁾(i) = d⁽⁰⁾(3i + 2) | |
| 8 | 2 | x⁽⁰⁾(i) = d⁽⁰⁾(4i) | M_{symb}^{layer} = M_{symb}⁽⁰⁾/4 = |
| | | x⁽¹⁾(i) = d⁽⁰⁾(4i + 1) | M_{symb}⁽¹⁾/4 |
| | | x⁽²⁾(i) = d⁽¹⁾(4i) | |
| | | x⁽³⁾(i) = d⁽¹⁾(4i + 2) | |
| | | x⁽⁴⁾(i) = d⁽¹⁾(4i + 3) | |
| | | x⁽⁵⁾(i) = d⁽¹⁾(4i + 4) | |
| | | x⁽⁶⁾(i) = d⁽⁰⁾(4i + 2) | |
| | | x⁽⁷⁾(i) = d⁽⁰⁾(4i + 3) | |

Referring to [Table 8], DM-RS antenna ports #11 and #12 are transmitted by applying CDM in a manner of adding a length−4 orthogonal code to transmission positions of DM-RS antenna ports #9 and #10. Therefore, all of DM-RS antenna ports #9, #10, #11, and #12 are transmitted through CDM on a specific subcarrier. DM-RS antenna ports #13 and #14 are transmitted by applying CDM in a manner of adding a length−4 orthogonal code to transmission positions of DM-RS antenna ports #7 and #8. Therefore, all of DM-RS antenna ports #7, #8, #13, and #14 are transmitted through CDM on a specific subcarrier.

As an embodiment, if the codeword-to-layer mapping schemes of [Table 7] and [Table 8] are defined as codeword-to-layer mapping (CLM) set #0 and CLM set #1, respectively, the present invention may apply CLM set #0 when the specific DCI indicates that the number of DLGs is 1. When the DCI indicates that the number of DLGs is 2, the present invention may apply CLM set #1.

FIG. 17 illustrates another example of the contents of DCI classified according to DLG according to an embodiment of the present invention. Unlike FIG. 16, it can be appreciated that an LMI field is configured in each DLG in FIG. 17.

More specifically, instead of the LMI field which is included only once in all DLGs as shown in FIG. 16, independent LMI fields are configured in respective DLGs. In this case, a conventional 3-bit table mapping scheme as shown in [Table 9] may be used without change. It is noted that since only one independent codeword is linked to each DLG, only a part related only to “One Codeword” in [Table 9] may be determined to be valid.

TABLE 9

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

In addition, according to the present invention, “One Codeword” in [Table 9] may be modified as shown below in [Table 10] and [Table 11].

TABLE 10
One Codeword

| Value | Message |
|---|---|
| 0 | 1 layer, port 7 |
| 1 | 2 layers, ports 7-8 |
| 2 | 3 layers, ports 7-9 |
| 3 | 4 layers, ports 7-10 |
| 4 | 5 layers, ports 7-11 |
| 5 | 6 layers, ports 7-12 |
| 6 | 7 layers, ports 7-13 |
| 7 | 8 layers, ports 7-14 |

TABLE 11
One Codeword

| Value | Message |
|---|---|
| 0 | 1 layer, port 7 |
| 1 | 1 layer, port 8 |
| 2 | 2 layers, ports 7-8 |
| 3 | 3 layers, ports 7-9 |
| 4 | 4 layers, ports 7-10 |
| 5 | 5 layers, ports 7-11 |
| 6 | 6 layers, ports 7-12 |
| 7 | 7 layers, ports 7-13 |

In the embodiment of [Table 10], each LMI is mapped to one layer (DM-RS antenna port #7) to 8 layers (DM-RS antenna ports #7 to #14) and thus one DLG can be transmitted through a maximum of 8 layers. That is, if LMI belonging to a specific DLG indicates the total number of layers that a UE can receive, this may be interpreted as indicating that another DLG except for this DLG cannot be configured. If LMI belonging to a specific DLG indicates a value smaller than the total number of layers, LMI in another DLG may be configured as the number of layers corresponding to the difference between the indicated value and the total number of layers.

Meanwhile, in [Table 11], it can be appreciated that a specific layer (layer 1 in [Table 11]) is configured to allocate different antenna ports. That is, in [Table 11], “1 layer, port 7” is indicated for LMI=1 and “1 layer, port 8” is indicated for LMI=0.

If the size of the LMI field is limited to 3 bits, LMI=7 indicates “7 layers, ports 7-13” unlike [Table 10]. That is, the maximum number of layers capable of being indicated in one DLG is limited to a value subtracting one from the total number of layers. Since a plurality of DLGs can be included in one DCI according to the ILJT scheme proposed in the present invention, one DLG cannot always configure all of the layers and may be understood as indicating up to a value subtracting one from the total number of layers.

As can be appreciated in [Table 10] and [Table 11], a part indicating conventional nSCID is deleted. That is, the present invention proposes that nSCID that should be used in a specific DLG be configured from a higher layer for each DLG or nSCID to be used for each DLG of DCI as shown in FIG. 17 be indicated.

An nSCID value that can conventionally be linked to each LMI may be independently configured according to a DLG, a UE, or specific DCI or according to whether a search space in which the specific DCI is detected is a common search space (CSS) or a UE-specific search space (USS) or whether the specific DCI is received on a PDCCH or an EPDCCH. Alternatively, the nSCID value may be limited only to a single value (e.g. nSCID=0) in only a specific transmission mode, especially, in the ILJT scheme.

In addition, the nSCID value may be determined to always be nSCID=0 with respect to a specific UE and the case in which a virtual cell-ID (VCI) differs according to a DLG (i.e., VCI1 is applied to DLG1 and VCI2 is applied to DLG2) may be considered. For example, in [Table 10], if the UE receives 2 as LMI belonging to DLG1 and 3 as LMI belonging to DLG2, the number of layers belonging to DLG1 is 3 and a DM-RS is detected by applying VCI1 and nSCID=0 with respect to DM-RS antenna ports #7 to #9. In addition, the number of layers belonging to DLG2 is 4 and a DM-RS is detected by applying VCI2 and nSCID=0 with respect to DM-RS antenna ports #7 to #10.

If the value of the PQI field indicated by each DLG differs, a DM-RS sequence may be generated by applying independent values of VCI and nSCID for each DLG In this case, it is desirable that the schemes shown in [Table 10] and [Table 11] be applied to the LMI. For example, when the UE can receive two parameter sets such as {VCI(1), nSCID(1)} and {VCI(2), nSCID(2)}, if the value of the PQI field indicated by each DLG in the received DCI differs, the DM-RS sequence may be generated by applying {VCI(1), nSCID(1)} to DLG1 and {VCI(2), nSCID(2)} to DLG2.

When LMI mapping of [Table 11] is applied, if the LMI of DLG1 is 2 and the LMI of DLG2 is 3, two layers for DLG1 generate the DM-RS sequence based on {VCI(1), nSCID(1)} on DM-RS antenna ports #7 and #8 and three layers for DLG2 generate the DM-RS sequence based on {VCI(2), nSCID(2)} on DM-RS antenna ports #7 to #9. That is, since a scrambling seed value expressed as {VCI, nSCID} differs according to DLG and DM-RS sequences are orthogonal, DM-RS antenna port mapping for each DLG is equally started from DM-RS antenna port #7 so that DM-RS overhead can be maximally reduced.

If the values of respective PQI fields indicated by each DLG are equal, the DM-RS sequence is generated by always applying the same VCI and/or nSCID value to all DLGs. In this case, it is proposed that a different DM-RS antenna port index be assigned to each DLG by applying a scheme shown in [Table 12] and [Table 13].

TABLE 12

| One Codeword for DLG1 | | One Codeword for DLG2 | |
|---|---|---|---|
| Value | Message | Value | Message (v = 7 + L + 1) |
| L = 0 | 1 layer, port 7 | 0 | 1 layer, port v |
| L = 1 | 2 layers, ports 7~8 | 1 | 2 layers, ports v~(v + 1) |
| L = 2 | 3 layers, ports 7~9 | 2 | 3 layers, ports v~(v + 2) |
| L = 3 | 4 layers, ports 7~10 | 3 | 4 layers, ports v~(v + 3) |
| L = 4 | 5 layers, ports 7~11 | 4 | 5 layers, ports v~(v + 4) |
| L = 5 | 6 layers, ports 7~12 | 5 | 6 layers, ports v~(v + 5) |
| L = 6 | 7 layers, ports 7~13 | 6 | 7 layers, ports v~(v + 6) |
| L = 7 | 8 layers, ports 7~14 | 7 | 8 layers, ports v~(v + 7) |

TABLE 13

| One Codeword for DLG1 | | One Codeword for DLG2 | |
|---|---|---|---|
| Value | Message | Value | Message (v = 7 + L + 1) |
| L = 0 | 1 layer, port 7 | 0 | 1 layer, port 7 |
| L = 1 | 1 layer, port 8 | 1 | 1 layer, port 8 |
| L = 2 | 2 layers, ports 7~8 | 2 | 2 layers, ports v~(v + 1) |
| L = 3 | 3 layers, ports 7~9 | 3 | 3 layers, ports v~(v + 2) |
| L = 4 | 4 layers, ports 7~10 | 4 | 4 layers, ports v~(v + 3) |
| L = 5 | 5 layers, ports 7~11 | 5 | 5 layers, ports v~(v + 4) |
| L = 6 | 6 layers, ports 7~12 | 6 | 6 layers, ports v~(v + 5) |
| L = 7 | 7 layers, ports 7~13 | 7 | 7 layers, ports v~(v + 6) |

According to [Table 12] and [Table 13], in consideration of the number L of layers indicated by a preceding DLG, a DM-S antenna port index indicated by a following DLG may be assigned starting from the last DM-RS antenna port index indicated by the preceding DLG plus 1. Then, DM-RS antenna port indexes do not overlap with each other in all DLGs and are allocated to be successively increased.

If the values of the PQI fields indicated by respective DLGs are equal, this may be interpreted as indicating that ILJT is not substantially applied. That is, DM-RS antenna port indexes are successively increased over all DLGs as in a conventional scheme and, therefore, the ILJT scheme or a single transmission point transmission scheme can be dynamically selected.

Parameter sets of {VCI(1), nSCID(1)} and {VCI(2), nSCID(2)} may be pre-configured for the UE and the UE may generate the DM-RS sequence by applying one (hereinafter, assumed as {VCI(1), nSCID(1)}) of the parameter sets for DLG1 and DLG2 when the values of the PQI fields indicated by the respective DLGs in the received DCI are equal. If LMI=1 for DLG1 and LMI=2 for DLG2, two layers for DLG1 generate the DM-RS sequence based on {VCI(1), nSCID(1)} on DM-RS antenna ports #7 and #8 and three layers for DLG2 generate the DM-RS sequence based on {VCI(1), nSCID(1)} on DM-RS antenna ports #9 to #11 through v=7+L+1=9 according to [Table 12].

The concept described in the present invention, indicating that the PQI field can be independently included in each DLG may be applied to a similar signaling format as follows.

For example, the PQI field may be present in the DCI only once as in the conventional scheme and a PQI parameter set linked to each state of the PQI field may additionally include the LMI and/or DM-RS antenna port mapping related information shown in [Table 10] to [Table 13] with respect to each DLG.

That is, a specific PQI state may include only information belonging to DLG1 and this may mean that the total number of DLGs corresponding to the PQI state is 1. Another PQI state may include information belonging to both DLG1 and DLG2 and this may mean that the number of DLGs corresponding to the PQI state is 2. In this way, the total number of DLGs in each PQI state may differ. The upper limit value of the number of DLGs may be reported by the UE during network access as UE capability information signaling. The upper limit value of the number of DLGs may also be configured by the eNB through RRC signaling.

In this case, the LMI field may not be included in the PQI field and may be present as an additional field of the DCI as in the conventional scheme. That is, if the number of DLGs is signaled according to the PQI state, the number of layers allocated to each DLG is indicated through the LMI field of the DCI. In this case, DM-RS antenna port mapping and antenna port indexing described with reference to [Table 10] to [Table 13] according to the number of layers may be additionally defined and indicated for each DLG

Additionally, the concept of configuration of a different PQI field for each DLG may be extended to differently configure a QCL type for DLG. That is, if specific DLG1 is set to QCL type A and if specific DLG2 is set to QCL type B, the UE receives a DM-RS antenna port by disregarding an RS with which a QCL assumption indicated by the PQI state of DLG1 can be made or applying a QCL assumption between a DM-RS and a CRS of a serving cell according to QCL type A in order to detect a DM-RS based PDSCH received through a layer corresponding to DLG1. Obviously, a quasi-collocated (QCLed) RS part may not be present in DLG1.

Meanwhile, in DLG2 set to QCL type B, the UE receives a DM-RS antenna port by applying a QCL assumption with a specific RS indicated by the PQI state of DLG2 in order to detect the DM-RS based PDSCH.

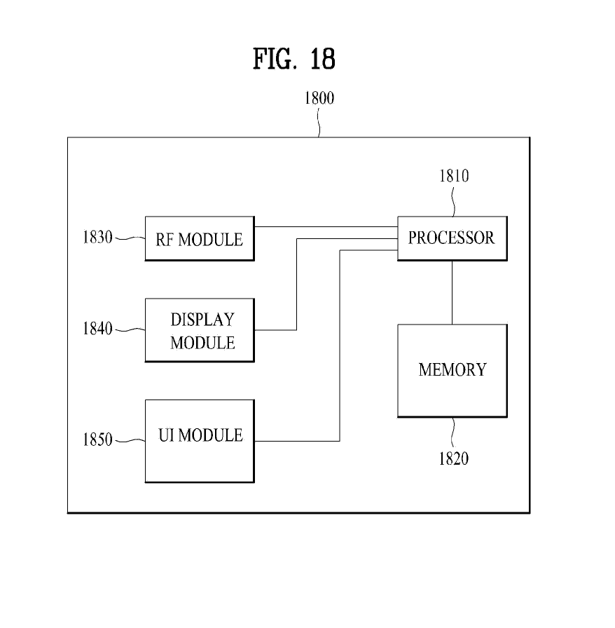

FIG. 18 is a block diagram for an example of a communication device according to one embodiment of the present invention.

Referring to FIG. 18, a communication device 1800 may include a processor 1810, a memory 1820, an RF module 1830, a display module 1840, and a user interface module 1850.

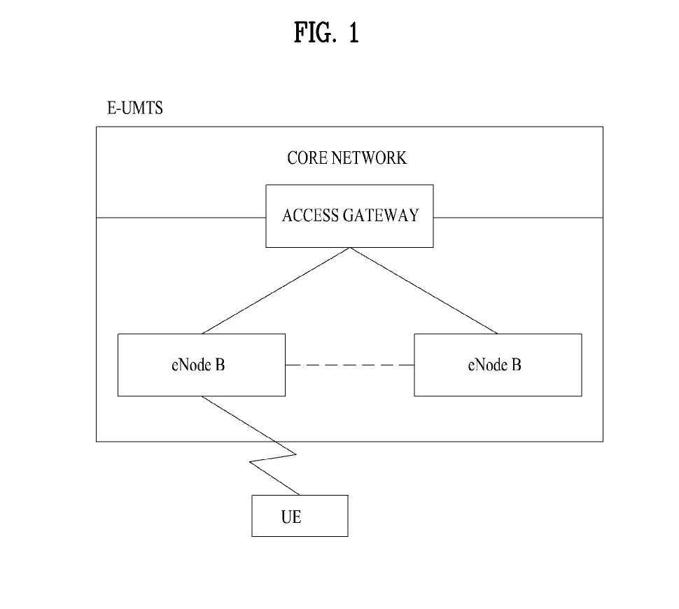

Since the communication device 1800 is depicted for clarity of description, prescribed module(s) may be omitted in part. The communication device 1800 may further include necessary module(s). And, a prescribed module of the communication device 1800 may be divided into subdivided modules. A processor 1810 is configured to perform an operation according to the embodiments of the present invention illustrated with reference to drawings. In particular, the detailed operation of the processor 1810 may refer to the former contents described with reference to FIG. 1 to FIG. 17.

The memory 1820 is connected with the processor 1810 and stores an operating system, applications, program codes, data, and the like. The RF module 1830 is connected with the processor 1810 and then performs a function of converting a baseband signal to a radio signal or a function of converting a radio signal to a baseband signal. To this end, the RF module 1830 performs an analog conversion, amplification, a filtering, and a frequency up conversion, or performs processes inverse to the former processes. The display module 1840 is connected with the processor 1810 and displays various kinds of informations. And, the display module 1840 can be implemented using such a well-known component as an LCD (liquid crystal display), an LED (light emitting diode), an OLED (organic light emitting diode) display and the like, by which the present invention may be non-limited. The user interface module 1850 is connected with the processor 1810 and can be configured in a manner of being combined with such a well-known user interface as a keypad, a touchscreen and the like.

The above-described embodiments correspond to combinations of elements and features of the present invention in prescribed forms. And, the respective elements or features may be considered as selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, a specific operation explained as performed by an eNode B may be performed by an upper node of the eNode B in some cases. In particular, in a network constructed with a plurality of network nodes including an eNode B, it is apparent that various operations performed for communication with a user equipment can be performed by an eNode B or other networks except the eNode B. ‘eNode B (eNB)’ may be substituted with such a terminology as a fixed station, a Node B, a base station (BS), an access point (AP) and the like.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

While the method for transmitting and receiving a signal in a multi-cell based wireless communication system and the apparatus therefor have been described in the context of a 3GPP LTE system, the present invention is also applicable to various wireless communication systems.

1. A method for receiving a signal by a user equipment in a multi-cell based wireless communication system, the method comprising:
configuring a plurality of parameter sets for receiving a downlink data channel through a higher layer;
receiving control information for receiving the downlink data channel from a serving cell; and
receiving the downlink data channel including a plurality of codewords through a plurality of layer groups from at least one of the serving cell and a neighboring cell based on the control information,
wherein one layer group corresponds to one codeword,
wherein the control information includes layer group information for each of the layer groups, and
wherein the layer group information includes information indicating one of the parameter sets.

2. The method according to claim 1,
wherein each of the layer groups includes one or more layers, and
wherein the layer group information includes information for mapping the one codeword to one or more layers.

3. The method according to claim 2,
wherein first reference signals for the downlink data channel are defined as different antenna ports,
wherein the first reference signals mapped to different layer groups are mapped to the one or more layers through frequency division multiplexing, and
wherein the first reference signals mapped to the same layer group are mapped to the one or more layers through code division multiplexing.

4. The method according to claim 1,
wherein the parameter sets include information about a second reference signal assumed to have the same large-scale properties as a first reference signal for the downlink data channel.

5. The method according to claim 4,
wherein the large-scale properties include at least one of Doppler spread, Doppler shift, average delay, and delay spread.

6. The method according to claim 4,
wherein the information about the second reference signal included in each of the layer group information is different.

7. The method according to claim 6,
wherein first reference signals for the downlink data channel are generated based on different cell identifiers for the respective layer groups.

8. A user equipment in a multi-cell based wireless communication system, the user equipment comprising:
a wireless communication module for transmitting and receiving a signal to and from a base station; and
a processor for processing the signal,
wherein the processor configures a plurality of parameter sets for receiving a downlink data channel through a higher layer and controls the wireless communication module to receive control information for receiving the downlink data channel from a serving cell and receive the downlink data channel including a plurality of codewords through a plurality of layer groups from at least one of the serving cell and a neighboring cell based on the control information, and
wherein one layer group corresponds to one codeword, the control information includes layer group information for each of the layer groups, and the layer group information includes information indicating one of the parameter sets.

9. The user equipment according to claim 9,
wherein each of the layer groups includes one or more layers, and
wherein the layer group information includes information for mapping the one codeword to one or more layers.

10. The user equipment according to claim 9,
wherein first reference signals for the downlink data channel are defined as different antenna ports,
wherein the first reference signals mapped to different layer groups are mapped to the one or more layers through frequency division multiplexing, and
wherein the first reference signals mapped to the same layer group are mapped to the one or more layers through code division multiplexing.

11. The user equipment according to claim 8,
wherein the parameter sets include information about a second reference signal assumed to have the same large-scale properties as a first reference signal for the downlink data channel.

12. The user equipment according to claim 11,
wherein the large-scale properties include at least one of Doppler spread, Doppler shift, average delay, and delay spread.

13. The user equipment according to claim 11,
wherein information about the second reference signal included in each of the layer group information is different.

14. The user equipment according to claim 13,
wherein first reference signals for the downlink data channel are generated based on different cell identifiers for the respective layer groups.
